(19) United States
(12) Patent Application Publication
(10) Pub. No.: US 2026/0361526 A1
(43) Pub. Date: Nov. 12, 2026

(54) SESSION KEY GENERATION FOR AMBIENT INTERNET OF THINGS DEVICES

(71) Applicant: Lenovo (United States) Inc., Morrisville, NC (US)

(72) Inventors: Andreas Kunz, Ladenburg (DE); Genadi Velev, Darmstadt (DE); Sheeba Backia Mary Baskaran, Friedrichsdorf (DE)

(73) Assignee: Lenovo (United States) Inc., Morrisville, NC (US)

(21) Appl. No.: 19/202,920

(22) Filed: May 8, 2025

(51) Int. Cl. H04L 9/08

(52) U.S. Cl. CPC H04L 9/0861

(57) ABSTRACT

Various aspects of the present disclosure relate to session key generation for ambient Internet of things (AIoT) devices. A first individual session key for an AIoT device is generated, for a first request, based at least in part on a pre-shared security key and optionally one or more additional parameters. A second individual session key for the AIoT device is also generated, for a second request, and based at least in part on the first individual session key and optionally one or more additional parameters.

### TECHNICAL FIELD

The present disclosure relates to wireless communications, and more specifically to session key generation for ambient Internet of things (AIoT) devices.

### BACKGROUND

A wireless communications system may include one or multiple network communication devices, such as base stations, which may be otherwise known as network equipment (NE), supporting wireless communications for one or multiple user communication devices, which may be otherwise known as user equipment (UE), or other suitable terminology. The wireless communications system may support wireless communications with one or multiple user communication devices by utilizing resources of the wireless communication system (e.g., time resources (e.g., symbols, slots, subframes, frames, or the like) or frequency resources (e.g., subcarriers, carriers, or the like)). Additionally, the wireless communications system may support wireless communications across various radio access technologies including third generation (3G) radio access technology, fourth generation (4G) radio access technology, fifth generation (5G) radio access technology, among other suitable radio access technologies beyond 5G (e.g., sixth generation (6G)).

### SUMMARY

As used herein, including in the claims, an article “a” before an element is unrestricted and understood to refer to “at least one” of those elements or “one or more” of those elements. The terms “a,” “at least one,” “one or more,” and “at least one of one or more” may be interchangeable. As used herein, including in the claims, “or” as used in a list of items (e.g., a list of items prefaced by a phrase such as “at least one of” or “one or more of” or “one or both of”) indicates an inclusive list such that, for example, a list of at least one of A, B, or C means A or B or C or AB or AC or BC or ABC (i.e., A and B and C). By way of another example, a list of at least one of A; B; or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.” Further, as used herein, including in the claims, a “set” may include one or more elements.

The devices (e.g., NE, UE), processors, and methods of the present disclosure each have several innovative aspects, no single one of which is solely responsible for the desirable features disclosed herein.

An NE (e.g., a base station) for wireless communication is described. The NE may be configured to, capable of, or operable to perform one or more operations as described herein. For example, the NE may be configured to, capable of, or operable to generate, for a first request and based at least in part on a pre-shared security key, a first individual session key for an AIoT device; and generate, for a second request and based at least in part on the first individual session key, a second individual session key for the AIoT device.

A processor (e.g., a standalone processor chipset, or a component of an NE (e.g., a base station)) for wireless communication is described. The processor may be configured to, capable of, or operable to perform one or more operations as described herein. For example, the processor may be configured to, capable of, or operable to generate, for a first request and based at least in part on a pre-shared security key, a first individual session key for an AIoT device; and generate, for a second request and based at least in part on the first individual session key, a second individual session key for the AIoT device.

A method performed or performable by an NE (e.g., a base station) for wireless communication is described. The method may include generating, for a first request and based at least in part on a pre-shared security key, a first individual session key for an AIoT device; and generating, for a second request and based at least in part on the first individual session key, a second individual session key for the AIoT device.

In some implementations of the NE, processor, and method described herein, the NE, processor, and method may further be configured to, capable of, performed, performable, or operable to transmit a request for device profile information corresponding to a target device information that identifies the AIoT device; and receive a permanent AIoT device identifier and the pre-shared security key that correspond to the AIoT device.

In some implementations of the NE, the processor, and the method described herein, the NE implements an AIoT function (AIoTF). In some implementations of the NE, the processor, and the method described herein, to transmit the request, the NE, processor, and method may further be configured to, capable of, performed, performable, or operable to transmit the request to an apparatus that implements AIoT data management (ADM).

In some implementations of the NE, processor, and method described herein, the NE, processor, and method may further be configured to, capable of, performed, performable, or operable to receive a request for device profile information corresponding to a target device information; generate an individual temporary identifier for the AIoT device that is identified by the target device information; and transmit the temporary identifier for the AIoT device, and at least one of the first individual session key or the second individual session key for the AIoT device. In some implementations of the NE, processor, and method described herein, the NE implements ADM.

In some implementations of the NE, processor, and method described herein, to receive the request, the NE, processor, and method may further be configured to, capable of, performed, performable, or operable to receive the request from an apparatus that implements an AIoTF. In some implementations of the NE, processor, and method described herein, the NE, processor, and method may further be configured to, capable of, performed, performable, or operable to input the pre-shared security key into a keyed-hash message authentication code (HMAC) function that outputs the first individual session key, and where to generate the second individual session key, the at least one processor is configured to cause the NE to input the pre-shared security key and the first individual session key into the HMAC function that outputs the second individual session key.

In some implementations of the NE, processor, and method described herein, the NE, processor, and method may further be configured to, capable of, performed, performable, or operable to input the pre-shared security key and a network-generated nonce into a HMAC function that outputs the first individual session key, and where to generate the second individual session key, the at least one processor is configured to cause the NE to input the pre-shared security key, the network-generated nonce, and the first individual session key into the HMAC function that outputs the second individual session key. In some implementations of the NE, processor, and method described herein, to generate the first individual session key, the NE, processor, and method may further be configured to, capable of, performed, performable, or operable to input the pre-shared security key, a network-generated nonce, and a permanent AIoT device identifier into a HMAC function that outputs the first individual session key, and where to generate the second individual session key, the at least one processor is configured to cause the NE to input the pre-shared security key, the network-generated nonce, the permanent AIoT device identifier, and the first individual session key into the HMAC function that outputs the second individual session key.

In some implementations of the NE, processor, and method described herein, the NE, processor, and method may further be configured to, capable of, performed, performable, or operable to input the pre-shared security key, a network-generated nonce, and a temporary AIoT device identifier into a HMAC function that outputs the first individual session key, and where to generate the second individual session key, the at least one processor is configured to cause the NE to input the pre-shared security key, the network-generated nonce, the temporary AIoT device identifier, and the first individual session key into the HMAC function that outputs the second individual session key.

In some implementations of the NE, processor, and method described herein, to generate the first individual session key, the NE, processor, and method may further be configured to, capable of, performed, performable, or operable to input the pre-shared security key, a network-generated nonce, a permanent AIoT device identifier, and an AIoT device-generated nonce into a HMAC function that outputs the first individual session key, and where to generate the second individual session key, the at least one processor is configured to cause the NE to input the pre-shared security key, the network-generated nonce, the permanent AIoT device identifier, the AIoT device-generated nonce, and the first individual session key into the HMAC function that outputs the second individual session key.

In some implementations of the NE, processor, and method described herein, to generate the first individual session key, the NE, processor, and method may further be configured to, capable of, performed, performable, or operable to input the pre-shared security key, a network-generated nonce, a temporary AIoT device identifier, and an AIoT device-generated nonce into a HMAC function that outputs the first individual session key, and where to generate the second individual session key, the at least one processor is configured to cause the NE to input the pre-shared security key, the network-generated nonce, the temporary AIoT device identifier, the AIoT device-generated nonce, and the first individual session key into the HMAC function that outputs the second individual session key.

A device (e.g., a UE or AIoT device) for wireless communication is described. The apparatus may be configured to, capable of, or operable to perform one or more operations as described herein. For example, the device may be configured to, capable of, or operable to receive a first request; generate an individual temporary identifier (ID) for the device; generate a first individual session key for the device based at least in part on a pre-shared security key corresponding to the device; transmit a response that includes the temporary ID.

A processor (e.g., a standalone processor chipset, or a component of a UE or of an AIoT) for wireless communication is described. The processor may be configured to, capable of, or operable to perform one or more operations as described herein. For example, the processor may be configured to, capable of, or operable to receive a first request; generate an individual temporary ID for the device; generate a first individual session key for the device based at least in part on a pre-shared security key corresponding to the device; transmit a response that includes the temporary ID.

A method performed or performable by a device (e.g., a UE or an AIoT device) for wireless communication is described. The method may include receiving a first request; generating an individual temporary ID for the device; generating a first individual session key for the device based at least in part on a pre-shared security key corresponding to the device; transmitting a response that includes the temporary ID.

In some implementations of the device, processor, and method described herein, the device, processor, and method may further be configured to, capable of, performed, performable, or operable to receive a second request; generate a second individual session key for the device based at least in part on the first individual session key. In some implementations of the device, processor, and method described herein, the device comprises an AIoT device.

In some implementations of the device, processor, and method described herein, to generate the first individual session key, the device, processor, and method may further be configured to, capable of, performed, performable, or operable to input the pre-shared security key, a network-generated nonce, and a permanent AIoT device identifier into a HMAC function that outputs the first individual session key, and where to generate the second individual session key, the at least one processor is configured to cause the device to input the pre-shared security key, the network-generated nonce, the permanent AIoT device identifier, and the first individual session key into the HMAC function that outputs the second individual session key. In some implementations of the device, processor, and method described herein, to generate the first individual session key, the device, processor, and method may further be configured to, capable of, performed, performable, or operable to input the pre-shared security key, a network-generated nonce, and a temporary AIoT device identifier into a HMAC function that outputs the first individual session key, and where to generate the second individual session key, the at least one processor is configured to cause the device to input the pre-shared security key, the network-generated nonce, the temporary AIoT device identifier, and the first individual session key into the HMAC function that outputs the second individual session key.

In some implementations of the device, processor, and method described herein, to generate the first individual session key, the device, processor, and method may further be configured to, capable of, performed, performable, or operable to input the pre-shared security key and a network-generated nonce into a HMAC function that outputs the first individual session key, and where to generate the second individual session key, the at least one processor is configured to cause the device to input the pre-shared security key, the network-generated nonce, and the first individual session key into the HMAC function that outputs the second individual session key. In some implementations of the device, processor, and method described herein, to generate the first individual session key, the device, processor, and method may further be configured to, capable of, performed, performable, or operable to input the pre-shared security key, a network-generated nonce, and a permanent AIoT device identifier into a HMAC function that outputs the first individual session key, and where to generate the first individual session key, the at least one processor is configured to cause the device to input the pre-shared security key, the network-generated nonce, the permanent AIoT device identifier, and the first individual session key into the HMAC function that outputs the second individual session key.

In some implementations of the device, processor, and method described herein, to generate the first individual session key, the device, processor, and method may further be configured to, capable of, performed, performable, or operable to input the pre-shared security key, a network-generated nonce, a permanent AIoT device identifier, and an AIoT device-generated nonce into a HMAC function that outputs the first individual session key, and where to generate the second individual session key, the at least one processor is configured to cause the device to input the pre-shared security key, the network-generated nonce, the permanent AIoT device identifier, the AIoT device-generated nonce, and the first individual session key into the HMAC function that outputs the second individual session key. In some implementations of the device, processor, and method described herein, to generate the first individual session key, the device, processor, and method may further be configured to, capable of, performed, performable, or operable to input the pre-shared security key, a network-generated nonce, a temporary AIoT device identifier, and an AIoT device-generated nonce into a HMAC function that outputs the first individual session key, and where to generate the second individual session key, the at least one processor is configured to cause the device to input the pre-shared security key, the network-generated nonce, the temporary AIoT device identifier, the AIoT device-generated nonce, and the first individual session key into the HMAC function that outputs the second individual session key.

### BRIEF DESCRIPTION OF THE DRAWINGS

FIG. 1 illustrates an example of a wireless communications system in accordance with aspects of the present disclosure.

FIG. 2 illustrates an example of an AIoT system in accordance with aspects of the present disclosure.

FIGS. 3A and 3B illustrate an example signaling flow in accordance with aspects of the present disclosure.

FIG. 4-11 illustrate examples of generating session keys in accordance with aspects of the present disclosure.

FIG. 12 illustrates an example of a device in accordance with aspects of the present disclosure.

FIG. 13 illustrates an example of a processor in accordance with aspects of the present disclosure.

FIG. 14 illustrates an example of an NE in accordance with aspects of the present disclosure.

FIG. 15 illustrates a flowchart of a method performed by a device in accordance with aspects of the present disclosure.

FIG. 16 illustrates a flowchart of a method performed by an NE in accordance with aspects of the present disclosure.

### DETAILED DESCRIPTION

An AIoT device refers to a low-power (e.g., self-powered) sensor or device, which is typically small and/or low-cost. AIoT devices are battery-less or have limited energy storage capability (e.g., using a capacitor) and the energy for the AIoT devices is provided through the harvesting of radio waves, light, motion, heat, or any other power source that could be seen suitable. Additionally, due to the expectation of low complexity, maintenance free and long life span (e.g., more than 10 years), small size and lower capabilities and lower power consumption than previously defined 3rd generation partnership project (3GPP) Internet of Things (IoT) devices (e.g., narrowband IoT (NB-IoT) or enhanced machine type communication (eMTC) devices), it is assumed that AIoT devices do not have a universal subscriber identity module (USIM) as a normal 3GPP defined UE but still are expected to have some certain level of security for communication.

One example of an AIoT device is a device (e.g., referred to as a passive device) that has no energy storage, no independent signal generation, and uses backscattering transmission. Another example of an AIoT device is a device (e.g., referred to as a semi-passive device) that has energy storage, no independent signal generation, and uses backscattering transmission. Use of stored energy can include amplification for reflected signals. Another example of an AIoT device is a device (e.g., referred to as an active device) that has energy storage, has independent signal generation (e.g., an active RF component for transmission), and may use backscattering transmission. For example, AIoT devices may include an energy harvester with an output power of from 1 microwatt (μW) to a few hundreds of μW. There are different topologies and deployment scenarios of AIoT. Examples of these topologies include a topology where a base station acts as reader and as source of a carrier wave, a topology where the base station acts as a reader but another device is used as a source of the carrier wave, a topology where the base station acts as a controller and another intermediate node is used as a reader and as a source of the carrier wave, and so forth.

One usage scenario for AIoT devices involves communication with multiple different AIoT devices, such as an indoor factory or warehouse area where AIoT devices are attached to items (e.g., products, boxes, pallets) being tracked, an office or factory where AIoT devices provide sensor data (e.g., temperature, humidity, noise level, light level), and the like. Two scenarios of communication towards the AIoT device are considered: an inventory request and a command request. An inventory request can be communicated (e.g., sent, transmitted) to an individual AIoT device that responds to the inventory request, or to a group of AIoT devices and all AIoT devices that receive the inventory request respond to the inventory request. A command request can be sent, transmitted, or communicated to an individual AIoT device and is performed after an inventory procedure (inventory request and response(s)) has been performed. A command request includes or identifies a command or operation, such as a read operation (e.g., to receive, retrieve, or obtain data or other information from the AIoT device), a write operation (e.g., to transmit, send, or provide data or other information to the AIoT device), a deactivate operation (e.g., to turn off or disable functionality of the AIoT device), an activate operation (e.g., to turn on or enable functionality of the AIoT device), and the like.

The command request has a preceding inventory request, and it is desirable to provide for confidentiality, integrity and replay protection for the command request and response. It is expected that an AIoT device will have a pre-shared key that is known to the AIoT device and the network (e.g., assigned to the AIoT device during manufacturing of the AIoT device), but using the same pre-shared key for the lifetime of the device without any update or change can lead to potential security issues (e.g., allowing information communicated to and/or from the AIoT device to be monitored by other devices, making it easier to decrypt or access the content of the command request and response, and so forth).

Using the techniques discussed herein, a session key is generated in an individual AIoT device and the network in order to protect the requests (e.g., command requests). The session key can be used (e.g., in place of the pre-shared key) to protect the content of the command request and response (e.g., defeat replay attacks, encrypting content). The session key is generated using a pre-shared security key that is known to the AIoT device and the network. In one or more implementations, the pre-shared security key and optionally one or more additional inputs are provided to a keyed-hash message authentication code (HMAC) function that outputs or generates the session key. Subsequent session keys can be derived from the previously generated session key, the pre-shared security key, and optionally one or more additional inputs provided to the HMAC function. The one or more additional inputs can include, for example, a network-generated nonce, an AIoT device-generated nonce, a temporary AIoT device identifier, a permanent AIoT device identifier, or combinations thereof.

A new session key can be generated for each session. Accordingly, a session key can also be referred to as an individual session key. A session refers to a request/response cycle (e.g., sending of the request and receiving of the response to the request). The session can be for different types of requests, such as inventory requests, command requests, and so forth. By generating a new session key for each session, security is improved because other devices that may be able to monitor communication between the network and the AIoT device will not be able to associate the communications with the AIoT device due to different session keys being used. The AIoT device and the network, however, will have access to the pre-shared security key and the one or more additional inputs provided to the HMAC function, so both the AIoT device and the network are able to associate the communications with the AIoT device.

Reference is made herein to communicating data or information, such as signaling communication resources and/or communications that are transmitted or received between devices. It is to be appreciated that other terms may be used interchangeably with communicating, such as signaling, transmitting, receiving, outputting, forwarding, retrieving, obtaining, and so forth.

Aspects of the present disclosure are described in the context of a wireless communications system. Aspects of the present disclosure are further set forth in the accompanying drawings and the description below. The description set forth herein, in connection with the accompanying drawings, describes example implementations and does not represent all the implementations that may be implemented or that are within the scope of the claims. The detailed description includes specific details for the purpose of providing an understanding of the described implementations. These implementations, however, may be practiced without these specific details. Additionally, the description set forth herein, in connection with the accompanying drawings is provided to enable a person having ordinary skill in the art to make or use the present disclosure. Various modifications to the disclosure will be apparent to a person having ordinary skill in the art, and the generic principles defined herein may be applied to other variations without departing from the scope of the present disclosure. Thus, the present disclosure is not limited to the examples and implementations described herein but is to be accorded the broadest scope consistent with the principles and novel features disclosed herein.

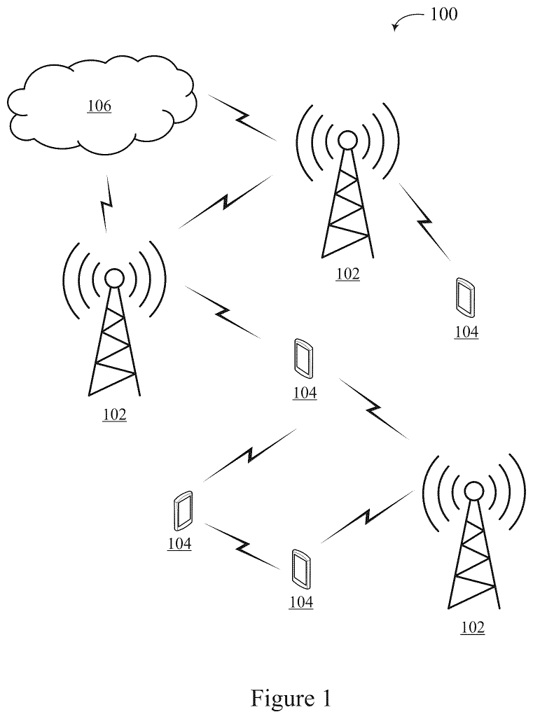

FIG. 1 illustrates an example of a wireless communications system 100 in accordance with aspects of the present disclosure. The wireless communications system 100 may include one or more NE 102, one or more UE 104, and a core network (CN) 106. The wireless communications system 100 may support various radio access technologies. In some implementations, the wireless communications system 100 may be a 4G network, such as an LTE network or an LTE-Advanced (LTE-A) network. In some other implementations, the wireless communications system 100 may be a new radio (NR) network, such as a 5G network, a 5G-Advanced (5G-A) network, or a 5G ultrawideband (5G-UWB) network. In other implementations, the wireless communications system 100 may be a combination of a 4G network and a 5G network, or other suitable radio access technology including Institute of Electrical and Electronics Engineers (IEEE) 802.11 (Wi-Fi), IEEE 802.16 (WiMAX), IEEE 802.20. The wireless communications system 100 may support radio access technologies beyond 5G, for example, 6G. Additionally, the wireless communications system 100 may support technologies, such as time division multiple access (TDMA), frequency division multiple access (FDMA), or code division multiple access (CDMA), etc.

The one or more NE 102 may be dispersed throughout a geographic region to form the wireless communications system 100. One or more of the NE 102 described herein may be or include or may be referred to as a network node, a base station, an access point (AP), a network element, a network function, a network entity, network infrastructure (or infrastructure), a radio access network (RAN), a NodeB, an eNodeB (eNB), a next-generation NodeB (gNB), or other suitable terminology. An NE 102 and a UE 104 may communicate via a communication link, which may be a wireless or wired connection. For example, an NE 102 and a UE 104 may perform wireless communication (e.g., receive signaling, transmit signaling) over a Uu interface.

An NE 102 may provide a geographic coverage area for which the NE 102 may support services for one or more UEs 104 within the geographic coverage area. For example, an NE 102 and a UE 104 may support wireless communication of signals related to services (e.g., voice, video, packet data, messaging, broadcast, etc.) according to one or multiple radio access technologies. In some implementations, an NE 102 may be moveable, for example, a satellite associated with a non-terrestrial network (NTN). In some implementations, different geographic coverage areas associated with the same or different radio access technologies may overlap, but the different geographic coverage areas may be associated with different NE 102.

The one or more UE 104 may be dispersed throughout a geographic region of the wireless communications system 100. A UE 104 may include or may be referred to as a remote unit, a mobile device, a wireless device, a remote device, a subscriber device, a transmitter device, a receiver device, or some other suitable terminology. In some implementations, the UE 104 may be referred to as a unit, a station, a terminal, or a client, among other examples. Additionally, or alternatively, the UE 104 may be referred to as an Internet-of-Things (IoT) device, an Internet-of-Everything (IoE) device, or machine-type communication (MTC) device, among other examples.

A UE 104 may be able to support wireless communication directly with other UEs 104 over a communication link. For example, a UE 104 may support wireless communication directly with another UE 104 over a device-to-device (D2D) communication link. In some implementations, such as vehicle-to-vehicle (V2V) deployments, vehicle-to-everything (V2X) deployments, or cellular-V2X deployments, the communication link may be referred to as a sidelink. For example, a UE 104 may support wireless communication directly with another UE 104 over a PC5 interface.

An NE 102 may support communications with the CN 106, or with another NE 102, or both. For example, an NE 102 may interface with other NE 102 or the CN 106 through one or more backhaul links (e.g., S1, N2, N6, or other network interface). In some implementations, the NE 102 may communicate with each other directly. In some other implementations, the NE 102 may communicate with each other indirectly (e.g., via the CN 106). In some implementations, one or more NE 102 may include subcomponents, such as an access network entity, which may be an example of an access node controller (ANC). An ANC may communicate with the one or more UEs 104 through one or more other access network transmission entities, which may be referred to as a radio heads, smart radio heads, or transmission-reception points (TRPs).

The CN 106 may support user authentication, access authorization, tracking, connectivity, and other access, routing, or mobility functions. The CN 106 may be an evolved packet core (EPC), or a 5G core (5GC), which may include a control plane entity that manages access and mobility (e.g., a mobility management entity (MME), an access and mobility management functions (AMF)) and a user plane entity that routes packets or interconnects to external networks (e.g., a serving gateway (S-GW), a packet data network (PDN) gateway (P-GW), or a user plane function (UPF)). In some implementations, the control plane entity may manage non-access stratum (NAS) functions, such as mobility, authentication, and bearer management (e.g., data bearers, signal bearers, etc.) for the one or more UEs 104 served by the one or more NE 102 associated with the CN 106.

The CN 106 may communicate with a packet data network over one or more backhaul links (e.g., via an S1, N2, N6, or other network interface). The packet data network may include an application server. In some implementations, one or more UEs 104 may communicate with the application server. A UE 104 may establish a session (e.g., a protocol data unit (PDU) session, or the like) with the CN 106 via an NE 102. The CN 106 may route traffic (e.g., control information, data, and the like) between the UE 104 and the application server using the established session (e.g., the established PDU session). The PDU session may be an example of a logical connection between the UE 104 and the CN 106 (e.g., one or more network functions of the CN 106).

In the wireless communications system 100, the NEs 102 and the UEs 104 may use resources of the wireless communications system 100 (e.g., time resources (e.g., symbols, slots, subframes, frames, or the like) or frequency resources (e.g., subcarriers, carriers)) to perform various operations (e.g., wireless communications). In some implementations, the NEs 102 and the UEs 104 may support different resource structures. For example, the NEs 102 and the UEs 104 may support different frame structures. In some implementations, such as in 4G, the NEs 102 and the UEs 104 may support a single frame structure. In some other implementations, such as in 5G and among other suitable radio access technologies, the NEs 102 and the UEs 104 may support various frame structures (i.e., multiple frame structures). The NEs 102 and the UEs 104 may support various frame structures based on one or more numerologies.

One or more numerologies may be supported in the wireless communications system 100, and a numerology may include a subcarrier spacing and a cyclic prefix. A first numerology (e.g., μ=0) may be associated with a first subcarrier spacing (e.g., 15 kHz) and a normal cyclic prefix. In some implementations, the first numerology (e.g., μ=0) associated with the first subcarrier spacing (e.g., 15 kHz) may utilize one slot per subframe. A second numerology (e.g., μ=1) may be associated with a second subcarrier spacing (e.g., 30 kHz) and a normal cyclic prefix. A third numerology (e.g., μ=2) may be associated with a third subcarrier spacing (e.g., 60 kHz) and a normal cyclic prefix or an extended cyclic prefix. A fourth numerology (e.g., μ=3) may be associated with a fourth subcarrier spacing (e.g., 120 kHz) and a normal cyclic prefix. A fifth numerology (e.g., μ=4) may be associated with a fifth subcarrier spacing (e.g., 240 kHz) and a normal cyclic prefix.

A time interval of a resource (e.g., a communication resource) may be organized according to frames (also referred to as radio frames). Each frame may have a duration, for example, a 10 millisecond (ms) duration. In some implementations, each frame may include multiple subframes. For example, each frame may include 10 subframes, and each subframe may have a duration, for example, a 1 ms duration. In some implementations, each frame may have the same duration. In some implementations, each subframe of a frame may have the same duration.

Additionally, or alternatively, a time interval of a resource (e.g., a communication resource) may be organized according to slots. For example, a subframe may include a number (e.g., quantity) of slots. The number of slots in each subframe may also depend on the one or more numerologies supported in the wireless communications system 100. For instance, the first, second, third, fourth, and fifth numerologies (i.e., μ=0, μ=1, μ=2, μ=3, μ=4) associated with respective subcarrier spacings of 15 kHz, 30 kHz, 60 kHz, 120 kHz, and 240 kHz may utilize a single slot per subframe, two slots per subframe, four slots per subframe, eight slots per subframe, and 16 slots per subframe, respectively. Each slot may include a number (e.g., quantity) of symbols (e.g., OFDM symbols). In some implementations, the number (e.g., quantity) of slots for a subframe may depend on a numerology. For a normal cyclic prefix, a slot may include 14 symbols. For an extended cyclic prefix (e.g., applicable for 60 kHz subcarrier spacing), a slot may include 12 symbols. The relationship between the number of symbols per slot, the number of slots per subframe, and the number of slots per frame for a normal cyclic prefix and an extended cyclic prefix may depend on a numerology. It should be understood that reference to a first numerology (e.g., μ=0) associated with a first subcarrier spacing (e.g., 15 kHz) may be used interchangeably between subframes and slots.

In the wireless communications system 100, an electromagnetic (EM) spectrum may be split, based on frequency or wavelength, into various classes, frequency bands, frequency channels, etc. By way of example, the wireless communications system 100 may support one or multiple operating frequency bands, such as frequency range designations FR1 (410 MHz-7.125 GHz), FR2 (24.25 GHz-52.6 GHz), FR3 (7.125 GHz-24.25 GHz), FR4 (52.6 GHz-114.25 GHz), FR4a or FR4-1 (52.6 GHz-71 GHz), and FR5 (114.25 GHz-300 GHz). In some implementations, the NEs 102 and the UEs 104 may perform wireless communications over one or more of the operating frequency bands. In some implementations, FR1 may be used by the NEs 102 and the UEs 104, among other equipment or devices for cellular communications traffic (e.g., control information, data). In some implementations, FR2 may be used by the NEs 102 and the UEs 104, among other equipment or devices for short-range, high data rate capabilities.

FR1 may be associated with one or multiple numerologies (e.g., at least three numerologies). For example, FR1 may be associated with a first numerology (e.g., μ=0), which includes 15 kHz subcarrier spacing; a second numerology (e.g., μ=1), which includes 30 kHz subcarrier spacing; and a third numerology (e.g., μ=2), which includes 60 kHz subcarrier spacing. FR 2 may be associated with one or multiple numerologies (e.g., at least 2 numerologies). For example, FR2 may be associated with a third numerology (e.g., μ=2), which includes 60 kHz subcarrier spacing; and a fourth numerology (e.g., μ=3), which includes 120 kHz subcarrier spacing.

One or more of the NEs 102 and/or the UEs 104 can be AIoT reader devices. An AIoT reader device refers to a device that receives, obtains, senses signaling from an AIoT device. An AIoT device in the wireless communications system 100 harvests energy (e.g., RF energy from other devices in the wireless communications system 100) to power the AIoT device and communicate (e.g., transmit, send, signal) data or information that is received, obtained, or sensed by the AIoT reader device.

An AIoT device refers to a low-power (e.g., self-powered) sensor or device, which is typically small and/or low-cost. For example, AIoT devices may include an energy harvester with an output power of from 1 microwatt (μW) to a few hundreds of μW. AIoT devices also typically do not include a subscriber identity module (SIM) card. There are different topologies and deployment scenarios of AIoT devices as discussed in more detail below.

In one or more implementations, the AIoT device may be a sensor (e.g., a tag), an actuator, an appliance, or another device capable of connecting to a wireless network. In some examples, the AIoT device is categorized according to a set of components and/or capabilities of the AIoT devices, where the categories include one or more of an active AIoT device category, a semi-passive AIoT device category, and/or a passive AIoT device category. An active AIoT device includes a power source and an active radio frequency component, such as a transmitter and/or receiver component, for signal generation. The transmitter and/or receiver component may include one or more antennas for transmitting and receiving signaling. A semi-passive AIoT device may have energy storage capabilities but may not include an active radio frequency component for signal generation. A passive AIoT device may not have energy storage capabilities or an active radio frequency component.

In some cases, semi-passive AIoT devices and passive AIoT devices use backscattering techniques and/or energy harvesting for transmitting and/or receiving transmissions. In variations, an active AIoT device may use a transmitter and/or receiver component for transmitting or receiving transmissions and/or may use backscattering techniques for transmitting and/or receiving transmissions. Semi-passive AIoT devices may use the stored energy to amplify a signal when using backscattering techniques. Backscattering techniques include receiving signaling from a source device (e.g., a node such as an intermediate node) and modulating a reflection of the incoming signaling towards a destination device (e.g., a reader node such as an intermediate node). Thus, the AIoT device may not use an active receiver and/or transmitter component for receiving and transmitting signaling, which reduces a power consumption level of the device.

In some examples, the AIoT device may be capable of energy harvesting using energy harvesting techniques. For example, the AIoT device may extract energy from transmission waves from a source device (e.g., an NE) to power the AIoT device. The source device may transmit the signaling using a continuous wave waveform in which the signaling has a constant amplitude and frequency and/or a carrier wave waveform in which the signaling has a periodic variation in amplitude, duration, and position. Signaling transmitted using a continuous wave waveform may be referred to as a continuous wave transmission, while signaling transmitted using a carrier wave waveform may be referred to as a carrier wave transmission. If the AIoT device includes an energy storage component, then the AIoT device may store the extracted energy for later use (e.g., to amplify a reflection of signal or to generate a new signal).

In one or more implementations, a pre-shared security key is used (optionally with a network-generated nonce (Nonce_nw)) as input to an HMAC function to derive a first session key. A nonce refers to a number (e.g., an arbitrary number, such as a randomly generated number or a pseudo-randomly generated number) that is used a limited number of times (e.g., used once, and then another nonce is generated). The following session keys can then be derived from the previous session key (optionally with a fresh Nonce_nw) so that the session key changes every time with each request. One or more additional parameters may also be input to the HMAC function, such as such as a temporary ID of the AIoT device, a permanent device ID of the AIoT device, an AIoT device-generated nonce (Nonce_d). The session keys can be generated by the AIoT device as well as one or more network devices (e.g., that implement an ADM or an AIoTF can generate the session keys.

The techniques discussed herein do not rely on the devices having a SIM or USIM and thus work with AIoT devices. The techniques discussed herein do not rely on a USIM as a main basis for the security, confidentiality, and integrity protection. The techniques discussed herein also work with low-power devices (e.g., AIoT devices that harvest energy from their environment (such as radio waves) and do not require large batteries for long lasting operation or a fixed power supply. The techniques discussed herein provide ultra-reliable communication and low latency to send information between machines for a smooth communication process. The techniques described herein are related to the ciphering of messages between the AIoT device and the corresponding network node, such as an AIoTF. The techniques described herein avoid usage of solely the pre-shared security key and address how to update and generate a session key in an individual AIoT device and the network in order to protect messages (e.g., command requests and responses).

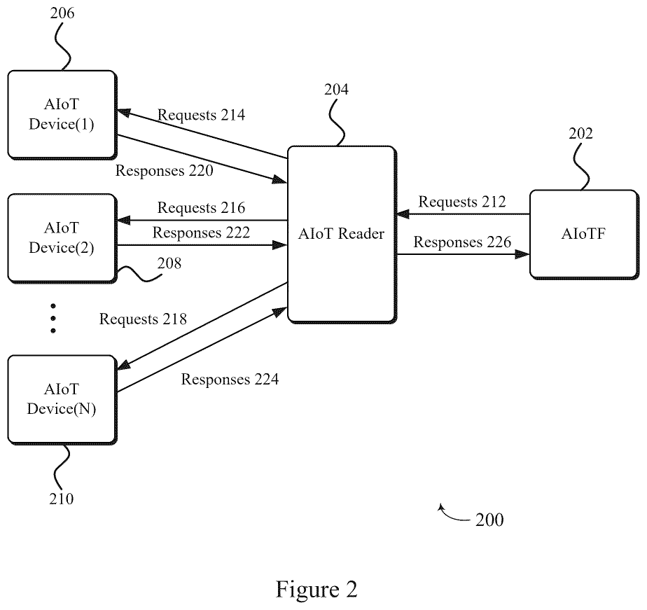

FIG. 2 illustrates an example of an AIoT system 200 in accordance with aspects of the present disclosure. The AIoT system 200 includes an AIoTF 202, an AIoT reader 204, and multiple (N) AIoT devices 206, 208, . . . , 210. The AIoTF 202 initiates one or more requests (e.g., inventory requests or command requests) targeting the AIoT devices 206, 208, . . . , 210, and takes various actions based on responses received from the AIoT devices 206, 208, . . . , 210. Initiating a request refers to beginning or starting a request. The AIoTF 202 can be part of, for example, a NE 102 (e.g., a base station) or a function in the CN 106. The AIoTF 202 transmits requests 212 to the AIoT reader 204, which in turn transmits requests 214, 216, . . . , 218 to the AIoT devices 206, 208, . . . , 210, respectively. The AIoT reader 204 is a device within communication range of the AIoT devices 206, 208, . . . , 210 that can communicate (e.g., transmit, send, signal) data or instructions to the AIoT devices 206, 208, . . . , 210 and can communicate (e.g., receive, obtain) data or instructions from the AIoT devices 206, 208, . . . , 210. The requests 212 as well as the requests 214, 216, . . . , 218 can be individual requests or group requests. An individual request targets or identifies a single one of the AIoT devices 206, 208, . . . , 210, whereas a group request targets or identifies a set of multiple AIoT devices 206, 208, . . . , 210. Sending a request (e.g., requests 212, 214, 216, . . . , 218) is also referred to as paging one or more AIoT devices. The AIoT devices 206, 208, . . . , 210 transmit responses 220, 222, . . . , 224, respectively, to the AIoT reader 204, which returns the responses 220, 222, . . . , 224 to the AIoTF 202 as responses 226.

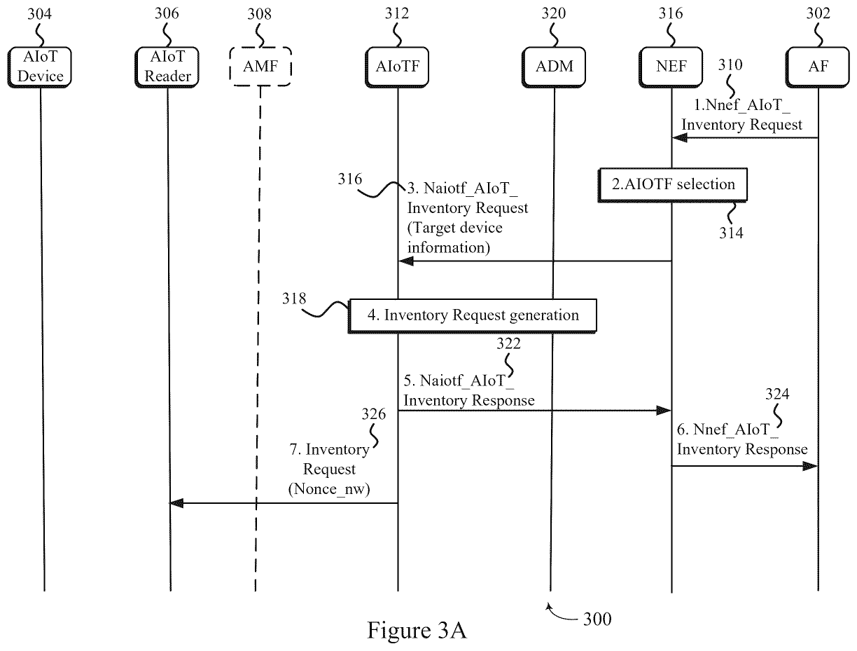

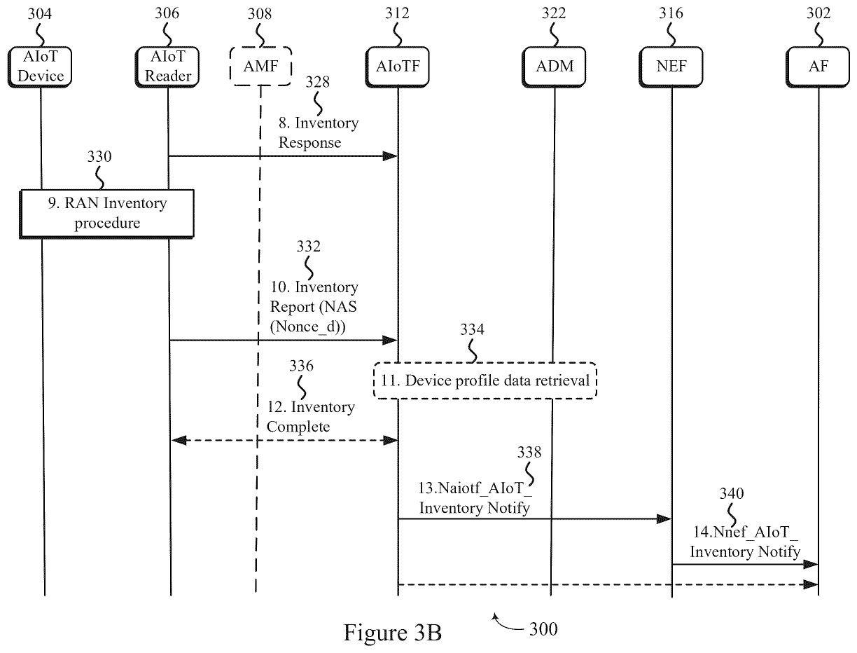

FIGS. 3A and 3B illustrate an example signaling flow 300 in accordance with aspects of the present disclosure. The example signaling flow 300 is a signaling flow for the transmission of an AIoT service request procedure (e.g., an inventory procedure) from an application function (AF) 302 to an AIoT device 304. Although the signaling flow 300 is discussed with reference to an inventory procedure, it is to be appreciated that the signaling flow 300 can be used with other types of procedures (e.g., a command procedure). An AIoT reader 306 can be a RAN node (e.g., an NG-RAN base station) or a UE reader. An AMF 308 is shown in the example signaling flow 300 with a dotted line as the example signaling flow 300 is common for both a direct path or direct connectivity architecture in which the AIoTF 312 communicates directly with the AIoT reader 306 and an indirect path or indirect connectivity architecture in which the AIoTF 312 communicates with the AIoT reader 306 via an AMF 308. Any AIoT application can communicate (e.g., transmit, send, signal, receive, obtain) AIoT data or control information with the AIoTF 312, and in a case of an untrusted AF, the AF can communicate (e.g., transmit, send, signal, receive, obtain) AIoT data or control information with the network exposure function (NEF) and the NEF communicates (e.g., transmits, sends, signals, receives, obtains) the AIoT data or control information with AIoTF 312.

At 310 (step 1), the AF 302 may send a request message for inventory for one or more AIoT devices. The AF 302 may invoke an Nnef_AIoT_Inventory request service operation and may include one or more of the parameters: AF ID, external target area information, information about the target one or more AIoT devices (also referred to as AIoT identification information). The information about the one or more target AIoT devices may include filtering information applied to the device ID (e.g., the AIoT device permanent ID), or include one or more AIoT device permanent IDs.

In one or more implementations of a trusted AF, if the AF 302 is configured to directly discover, select, and contact the AIoTF 312, the trusted AF 302 may send the request message for inventory directly to the AIoTF 312.

At 314 (step 2), the NEF 316 may further authorize the AF request in order to determine whether the AF 302 is eligible to use the requested network service(s). The NEF 316 may determine the target area information, and select one or more AIoTFs to handle the service request.

At 316 (step 3), the NEF 316 transmits the inventory request message to the selected AIoTF 312. The NEF 316 may invoke the service operation Naiotf_AIoT_Inventory request including the information about the target one or more AIoT devices.

At 318 (step 4), upon reception of the AIoT service request (e.g., inventory request), the AIoTF 312 may verify the parameters included in the request, e.g., whether the service request is authorized for the requested AIoT devices and/or for the target area.

If the AIoTF 312 does not store a device temporary ID, the AIoTF 312 may send a request message to the ADM 320 including the AIoT device permanent ID and an indication that the device temporary ID corresponding to the AIoT device permanent ID is requested. The ADM 320 provides to the AIoTF 312 the device temporary ID corresponding to the complete AIoT device ID.

The ADM 320 is a function that is responsible for the management of AIoT device profile data. The ADM 320 is similar to a unified data management (UDM)/unified data repository (UDR) where the UE data profiles and subscription data is stored, but the ADM 320 manages and stores profiles of AIoT devices such as the AIoT device permanent ID, the corresponding credentials of the AIoT device and possible last known location of the AIoT device.

If the AIoT service operation request cannot be processed, the AIoTF 312 rejects the AIoT service operation request with an appropriate cause code in step 5 below, and steps 7 through 14 are skipped.

At 322 (step 5), the AIoTF 312 sends an AIoT inventory service response to the NEF 316 (or directly to the AF 302) including the result (e.g., accept or reject) for the AIoT inventory service operation request based on the outcome of step 4 above.

At 324 (step 6), the NEF 316 sends the AIoT service operation response to the AF 302, including the accept or reject result for the AIoT inventory service operation request.

At 326 (step 7), the AIoTF 312 sends the inventory request message to the selected RAN node (e.g., AIoT reader 306) as its final destination. The message may include a Correlation ID and cryptographic nonce information (Nonce_nw). It should be noted that the cryptographic nonce information (Nonce_nw) is created in the network (e.g., in the ADM 320 or the AIoTF 312).

In step 4 above, or later in step 13 below, the network generated Nonce_nw in step 7 may be generated in the AIoTF 312 or in the ADM 320. The ADM 320 or the AIoTF 312 may generate the session key for the command request protection at the time they also generate the temporary identifier for the AIoT devices in a group or individual devices.

In one or more implementations, the session key is generated in the ADM 320. When the ADM 320 is queried for the Temporary IDs, the ADM 320 may generate also for each member in the group (in case of group inventory), identified by the target device information, the corresponding session keys and temporary identifiers. If the Nonce_nw is generated in the AIoTF 312, then the AIoTF 312 provides the Nonce_nw to the ADM for the key derivation.

Alternatively, or additionally, the session key is generated in the AIoTF 312. The ADM 320 gives the permanent AIoT device identifiers and the corresponding pre-shared security keys of the AIoT devices identified by the target device information to the AIoTF 312, which then generates the temporary identifiers and the corresponding session keys. If the Nonce_nw is generated in the ADM 320, then the ADM 320 provides the Nonce_nw to the AIoTF 312 for the key derivation.

The AIoT device 304 generates the session key at the time when it updates the temporary identifier, e.g., at the time the AIoT device 304 receives the inventory request or a command request in step 9 below.

At 328 (step 8), the AIoT reader 306 sends an inventory response message to the AIoTF 312. The Correlation ID is used by the AIoT reader 306 in the inventory response message by using the same Correlation ID. By this, the AIoTF 312 can correlate the messages in step 7 and step 10 below.

At 330 (step 9), upon reception of the inventory request message from the AIoTF 312, the AIoT reader(s) 306 execute the inventory operation. The AIoT reader(s) 306 broadcast the paging message that includes the AIoT identification information. The AIoT device 304 determines whether the received AIoT device identification information (e.g., filter information) matches the corresponding part of the AIoT device permanent ID configured in the AIoT device 304. If the AIoT device 304 determines that there is a match, the AIoT device 304 creates and sends a response to the paging message. The response may include an AIoT NAS message.

At 332 (step 10), the AIoT reader 306 sends one or more inventory report messages to the AIoTF 312 including the Correlation ID (as per step 7 above), Reader ID and one or more AIoT NAS messages from the AIoT devices. The AIoTF 312 stores the mapping between the Reader ID and AIoT device ID(s).

At 334 (step 11), the AIoTF 312 performs a procedure to validate the inventory report message, using locally stored AIoT device context or the AIoTF 312 may request the ADM 320 to verify the result message device profile data retrieved from the ADM 320. The received one or more AIoT NAS messages from the AIoT devices may include an AIoT device temporary ID and additional cryptographic information from (e.g., generated by) the AIoT device 304 (e.g., cryptographic Nonce_d).

At 336 (step 12), if the AIoT reader 306 detects that no more AIoT devices will respond to the inventory procedure, the AIoT reader 306 informs the AIoTF 312 that the procedure is complete.

At 338 (step 13), the AIoTF 312 reports the progress of the AIoT inventory request to the NEF 316 by sending the Naiotf_AIoT_Notify message including a list of one or more AIoT device permanent identifiers. The AIoTF 312 may send multiple reports. The AIoTF 312 in the final Naiotf_AIoT_Notify message may indicate that this is the last report for this operation. If multiple AIoTFs 312 are involved in the procedure, the NEF 316 may receive the AIoT_Notify from multiple AIoTFs 312. The AIoTF 312 is expected to store a context for each AIoT device at least for the time duration from receiving the AIoT service request from the AF 302 until the completion of the AIoT procedure and reporting back the result to the AF 302.

At 336 (step 12), when receiving the Naiotf_AIoT_Notify message from the AIoTF 312, the NEF 316 informs the AF 302 of the outcome of the AIoT_Inventory request by sending the Nnef_AIoT_Notify message(s) including the AIoT device permanent identifier(s). The NEF 316 in the final Nnef_AIoT_Notify message indicates that it is the last report for this operation.

Additionally, or alternatively, in steps 12 and 13, the AIoTF 312 may send the response message corresponding to the AIoT inventory request from step 1 directly to the AF 302 (e.g., without including the NEF 316).

At 338 (step 13), the AIoTF 312 reports the progress of the AIoT inventory request to the NEF 316 by sending the Naiotf_AIoT_Notify message including a list of AIoT device permanent identifier(s). The AIoTF 312 may send multiple reports. The AIoTF 312 in the final Naiotf_AIoT_Notify message indicates it is the last report for this operation. If multiple AIoTFs are involved in the procedure, the NEF may receive the AIoT_Notify from multiple AIoTFs.

At 340 (step 14), when receiving the Naiotf_AIoT_Notify message from the AIoTF 312, the NEF 316 informs the AF 302 of the outcome of the AIoT_Inventory request by sending the Nnef_AIoT_Notify message(s) including the AIoT device permanent identifier(s). The NEF 316 in the final Nnef_AIoT_Notify message indicates that it is the last report for this operation.

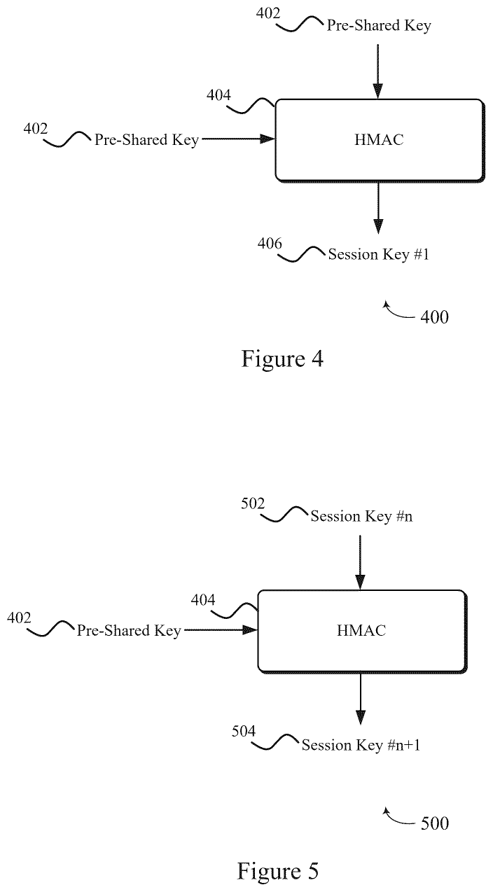

FIG. 4-11 illustrate examples of deriving or generating a session key. The session key is derived in the AIoT device 304 and in the AIoTF 312 (or the ADM 320). It is to be appreciated that there may be more input parameters to the HMAC function than those illustrated in FIG. 4-11, such as the length of the parameter, and so forth. FIG. 4-11 refer to a pre-shared key, which is a key known to both the AIoT device 304 and the network (e.g., the AIoTF 312 or the ADM 320). The pre-shared key is, for example, a factory-assigned key (e.g., assigned to the AIoT device).

FIG. 4 illustrates an example 400 of generating an initial session key in accordance with aspects of the present disclosure. In the example 400, the pre-shared key 402 is used as the input to an HMAC function 404 (e.g., a keyed hash function), which outputs (e.g., results in) a first session key 406. The session key 406 is also referred to as a first session key or an initial session key. In the example 400, the pre-shared key 402 is input to the HMAC function 404 as both the cryptographic key for the HMAC function 404 and as message or data input to the HMAC function 404.

FIG. 5 illustrates an example 500 of generating additional session keys in accordance with aspects of the present disclosure. The additional session keys are keys after or following the initial session key generated in the example 400 of FIG. 4. The following session keys are derived from the previous session key so that the key changes every time with each request. In the example 500, the pre-shared key 402 is input to the HMAC function 404 (e.g., as the cryptographic key for the HMAC function 404) and the previous session key 502 is also input to the HMAC function 404 (e.g., as the message or data input to the HMAC function), and the HMAC function 404 outputs the session key 504. In a case where the key derivation is reset and starts again from the beginning, e.g., with the pre-shared key 402 as input, then the same keys in the same sequence will be generated by the HMAC function 404.

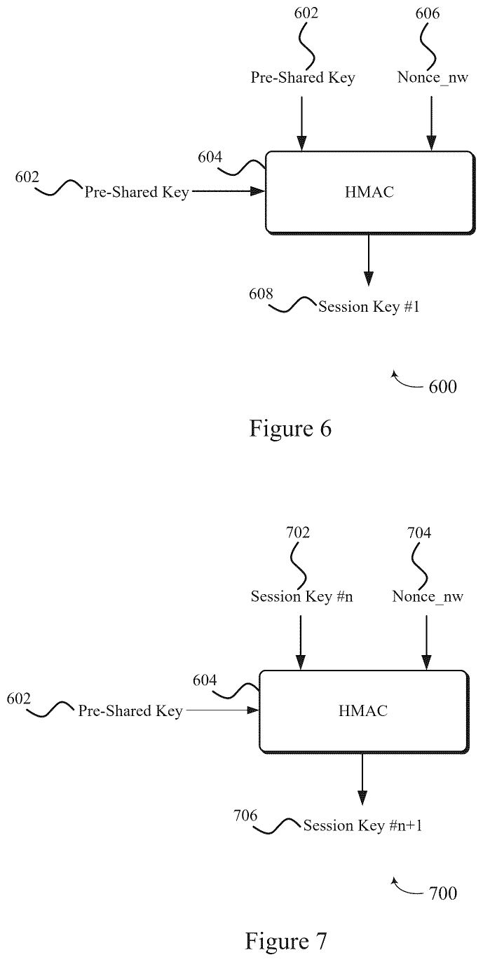

FIG. 6 illustrates an example 600 of generating an initial session key in accordance with aspects of the present disclosure. In the example 600, the pre-shared key and the network-generated (Nonce_nw) are used as inputs to the HMAC function. As illustrated, the pre-shared key 602 is input to the HMAC function 604 (e.g., as the cryptographic key for the HMAC function 604 and as part of the message or data input to the HMAC function 604) and the network-generated nonce 606 (Nonce_nw) is also input to the HMAC function 604 (e.g., as part of the message or data input to the HMAC function), resulting in a first session key 608.

FIG. 7 illustrates an example 700 of generating additional session keys in accordance with aspects of the present disclosure. The additional session keys are keys after or following the initial session key generated in the example 600 of FIG. 6. The following session keys are derived from the previous session key with a fresh Nonce_nw so that the session key changes every time with each request. In a case where the key derivation is reset and starts again from the beginning, e.g., the pre-shared key is input, then because the Nonce_nw changes with every inventory request or command request, the session keys are all different, assuming a variation of the Nonce_nw. With a high variation of the Nonce_nw, e.g., the network would not assign the same Nonce_nw for a long time, then also the derivation in FIG. 4 can be used for subsequent key derivation to achieve different and non-repeating session keys. As illustrated, the pre-shared key 602 is input to the HMAC function 604 (e.g., as the cryptographic key for the HMAC function 604) and the previous session key 702 and the Nonce_nw 704 are also input to the HMAC function 604 (e.g., the message or data input to the HMAC function), resulting in the session key 706.

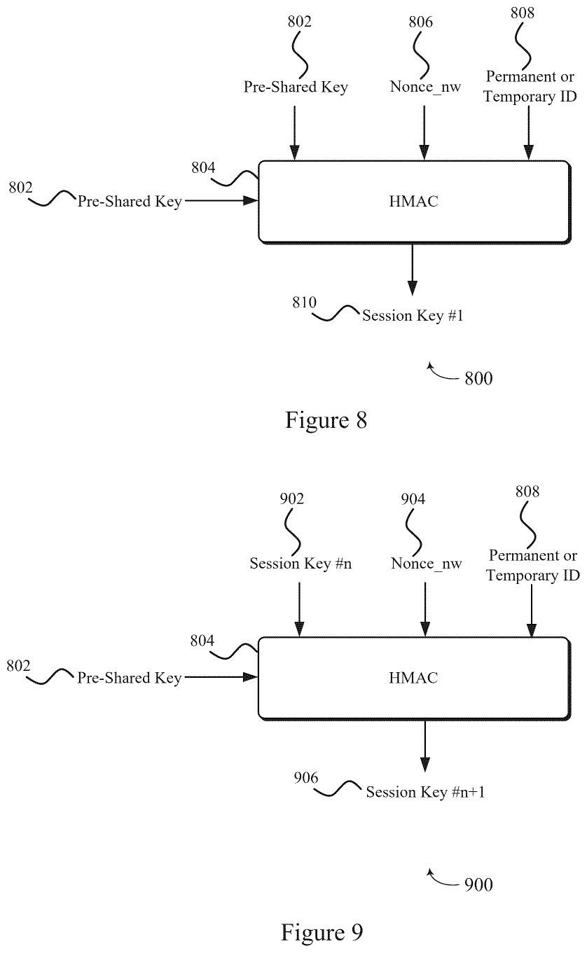

FIG. 8 illustrates an example 800 of generating an initial session key in accordance with aspects of the present disclosure. In the example 800, the pre-shared key, the network-generated (Nonce_nw), and the permanent AIoT device ID or a temporary AIoT device ID are used as inputs to the HMAC function. As illustrated, the pre-shared key 802 is input to the HMAC function 804 (e.g., as the cryptographic key for the HMAC function 804 and as part of the message or data input to the HMAC function 804) and the network-generated nonce 806 (Nonce_nw) and the permanent AIoT device ID or a temporary AIoT device ID 808 is also input to the HMAC function 804 (e.g., as part of the message or data input to the HMAC function), resulting in a first session key 810.

FIG. 9 illustrates an example 900 of generating additional session keys in accordance with aspects of the present disclosure. The additional session keys are keys after or following the initial session key generated in the example 800 of FIG. 8. If the temporary AIoT device ID is generated with the Nonce_nw, then the temporary AIoT device ID would not bring additional freshness into the session key derivation. The permanent ID (permanent AIoT device ID) does not change, and the key derivation is then just bound to the permanent AIoT device ID.

The following session keys are then derived from the previous session key with a fresh Nonce_nw so that the session key changes every time with each request as shown in FIG. 9. In a case where the key derivation is reset and starts again from the beginning, e.g., the pre-shared key as input, then because the Nonce_nw changes with every inventory or command request, the session keys are all different, assuming a variation of the Nonce_nw. With a high variation of the Nonce_nw, e.g., the network would not assign the same Nonce_nw for a long time, then also the derivation in FIG. 8 can be used for subsequent key derivation to achieve different and non-repeating session keys.

As illustrated, the pre-shared key 802 is input to the HMAC function 804 (e.g., as the cryptographic key for the HMAC function 804) and the previous session key 902, the Nonce_nw 904, and the permanent AIoT device ID or a temporary AIoT device ID 808 are also input to the HMAC function 804 (e.g., the message or data input to the HMAC function), resulting in the session key 906.

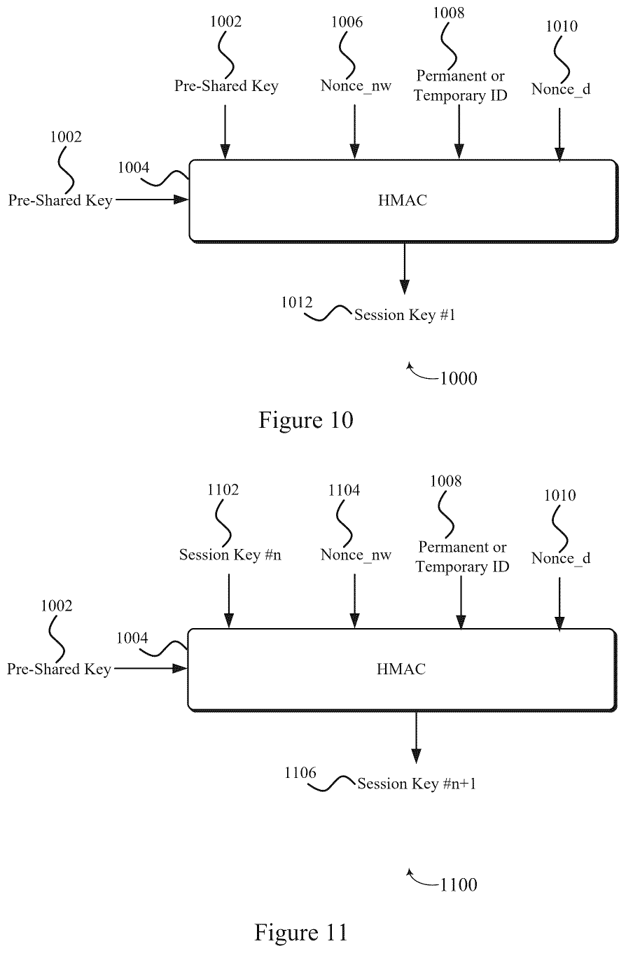

FIG. 10 illustrates an example 1000 of generating an initial session key in accordance with aspects of the present disclosure. In the example 1000, the pre-shared key, the network-generated (Nonce_nw), the permanent AIoT device ID or a temporary AIoT device ID, and an AIoT device generated nonce (Nonce_d) are used as inputs to the HMAC function. As illustrated, the pre-shared key 1002 is input to the HMAC function 1004 (e.g., as the cryptographic key for the HMAC function 1004 and as part of the message or data input to the HMAC function 1004) and the network-generated nonce 1006 (Nonce_nw), the permanent AIoT device ID or a temporary AIoT device ID 1008, and the AIoT device generated nonce (Nonce_d) 1010 are also input to the HMAC function 1004 (e.g., as part of the message or data input to the HMAC function), resulting in a first session key 1012.

FIG. 11 illustrates an example 1100 of generating additional session keys in accordance with aspects of the present disclosure. The additional session keys are keys after or following the initial session key generated in the example 1000 of FIG. 10. If the temporary ID and the Nonce_d are generated with the Nonce_nw, then the temporary AIoT device ID and the Nonce_d would not bring additional freshness into the session key derivation. The permanent AIoT device ID does not change, and the key derivation in this case is then just bound to the permanent AIoT device ID.

The following session keys are then derived from the previous session key with a fresh Nonce_nw so that the session key changes every time with each request as shown in FIG. 11. In a case where the key derivation is reset and starts again from the beginning, e.g., the pre-shared key as input, then because the Nonce_nw changes with every inventory or command request, the session keys are all different, assuming a variation of the Nonce_nw. With a high variation of the Nonce_nw, e.g., the network would not assign the same Nonce_nw for a long time, then also the derivation in FIG. 10 can be used for subsequent key derivation to achieve different and non-repeating session keys.

As illustrated, the pre-shared key 1002 is input to the HMAC function 1004 (e.g., as the cryptographic key for the HMAC function 1004) and the previous session key 1102, the Nonce_nw 1104, the permanent AIoT device ID or a temporary AIoT device ID 1008, and the Nonce_d 1010 are also input to the HMAC function 1004 (e.g., the message or data input to the HMAC function), resulting in the session key 1106.

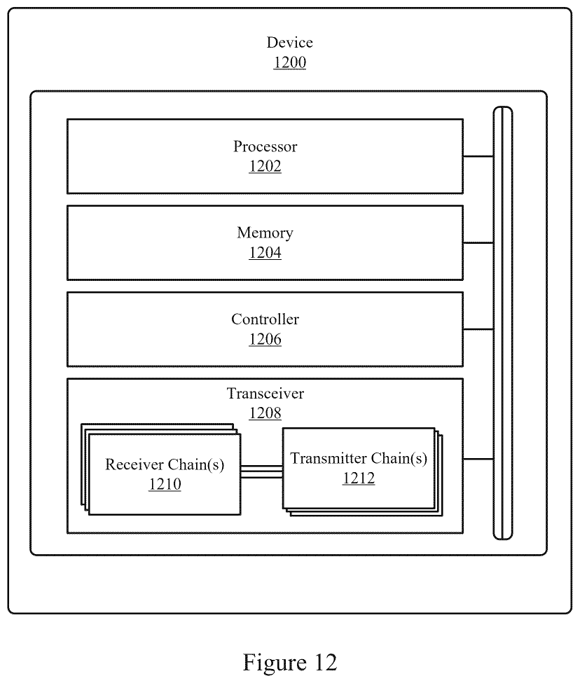

FIG. 12 illustrates an example of a device 1200 in accordance with aspects of the present disclosure. The device 1200 may include a processor 1202, a memory 1204, a controller 1206, and a transceiver 1208. The processor 1202, the memory 1204, the controller 1206, or the transceiver 1208, or various combinations thereof or various components thereof may be examples of means for performing various aspects of the present disclosure as described herein. These components may be coupled (e.g., operatively, communicatively, functionally, electronically, electrically) via one or more interfaces. The device 1200 may be a low power device (e.g., an AIoT device), a UE, a wireless device associated with a carrier wave (e.g., an external carrier wave node as discussed above), and so forth.

The processor 1202, the memory 1204, the controller 1206, or the transceiver 1208, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 1202 may include an intelligent hardware device (e.g., a general-purpose processor, a DSP, a CPU, an ASIC, an FPGA, or any combination thereof). In some implementations, the processor 1202 may be configured to operate the memory 1204. In some other implementations, the memory 1204 may be integrated into the processor 1202. The processor 1202 may be configured to execute computer-readable instructions stored in the memory 1204 to cause the device 1200 to perform various functions of the present disclosure.

The memory 1204 may include volatile or non-volatile memory. The memory 1204 may store computer-readable, computer-executable code including instructions when executed by the processor 1202 cause the device 1200 to perform various functions described herein. The code may be stored in a non-transitory computer-readable medium such as the memory 1204 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 1202 and the memory 1204 coupled with the processor 1202 may be configured to cause the device 1200 to perform one or more of the functions described herein (e.g., executing, by the processor 1202, instructions stored in the memory 1204). For example, the processor 1202 may support wireless communication at the device 1200 in accordance with examples as disclosed herein. The device 1200 may be configured to or operable to support a means for receiving a first request; generating an individual temporary ID for the device; generating a first individual session key for the device based at least in part on a pre-shared security key corresponding to the device; transmitting a response that includes the temporary ID.

Additionally, the device 1200 may be configured to support any one or combination of receiving a second request; generating a second individual session key for the device based at least in part on the first individual session key; where the device comprises an AIoT device; where generating the first individual session key includes inputting the pre-shared security key, a network-generated nonce, and a permanent AIoT device identifier into a HMAC function that outputs the first individual session key, and generating the second individual session key comprises inputting the pre-shared security key, the network-generated nonce, the permanent AIoT device identifier, and the first individual session key into the HMAC function that outputs the second individual session key; where generating the first individual session key includes inputting the pre-shared security key, a network-generated nonce, and a temporary AIoT device identifier into a HMAC function that outputs the first individual session key, and where generating the second individual session key includes inputting the pre-shared security key, the network-generated nonce, the temporary AIoT device identifier, and the first individual session key into the HMAC function that outputs the second individual session key; where generating the first individual session key includes inputting the pre-shared security key into a HMAC function that outputs the first individual session key, and where generating the second individual session key includes inputting the pre-shared security key and the first individual session key into the HMAC function that outputs the second individual session key; where generating the first individual session key includes inputting the pre-shared security key and a network-generated nonce into a HMAC function that outputs the first individual session key, and where generating the second individual session key includes inputting the pre-shared security key, the network-generated nonce, and the first individual session key into the HMAC function that outputs the second individual session key; where generating the first individual session key includes inputting the pre-shared security key, a network-generated nonce, a permanent AIoT device identifier, and an AIoT device-generated nonce into a HMAC function that outputs the first individual session key, and generating includes inputting the pre-shared security key, the network-generated nonce, the permanent AIoT device identifier, the AIoT device-generated nonce, and the first individual session key into the HMAC function that outputs the second individual session key; where generating the first individual session key includes inputting the pre-shared security key, a network-generated nonce, a temporary AIoT device identifier, and an AIoT device-generated nonce into a HMAC function that outputs the first individual session key, and where generating the second individual session key includes inputting the pre-shared security key, the network-generated nonce, the temporary AIoT device identifier, the AIoT device-generated nonce, and the first individual session key into the HMAC function that outputs the second individual session key.

Additionally, or alternatively, the device 1200 may support at least one memory (e.g., the memory 1204) and at least one processor (e.g., the processor 1202) coupled with the at least one memory and configured to cause the UE to: receive a first request; generate an individual temporary ID for the device; generate a first individual session key for the device based at least in part on a pre-shared security key corresponding to the device; transmit a response that includes the temporary ID.

Additionally, the device 1200 may be configured to support any one or combination of where the at least one processor is operable to cause the device to: receive a second request; generate a second individual session key for the device based at least in part on the first individual session key; where the device comprises an AIoT device; where to generate the first individual session key, the at least one processor is configured to cause the device to input the pre-shared security key, a network-generated nonce, and a permanent AIoT device identifier into a HMAC function that outputs the first individual session key, and where to generate the second individual session key, the at least one processor is configured to cause the device to input the pre-shared security key, the network-generated nonce, the permanent AIoT device identifier, and the first individual session key into the HMAC function that outputs the second individual session key; where to generate the first individual session key, the at least one processor is configured to cause the device to input the pre-shared security key, a network-generated nonce, and a temporary AIoT device identifier into a HMAC function that outputs the first individual session key, and where to generate the second individual session key, the at least one processor is configured to cause the device to input the pre-shared security key, the network-generated nonce, the temporary AIoT device identifier, and the first individual session key into the HMAC function that outputs the second individual session key; where to generate the first individual session key, the at least one processor is configured to cause the device to input the pre-shared security key into a HMAC function that outputs the first individual session key, and where to generate the second individual session key, the at least one processor is configured to cause the device to input the pre-shared security key and the first individual session key into the HMAC function that outputs the second individual session key; where to generate the first individual session key, the at least one processor is configured to cause the device to input the pre-shared security key and a network-generated nonce into a HMAC function that outputs the first individual session key, and where to generate the second individual session key, the at least one processor is configured to cause the device to input the pre-shared security key, the network-generated nonce, and the first individual session key into the HMAC function that outputs the second individual session key; where to generate the first individual session key, the at least one processor is configured to cause the device to input the pre-shared security key, a network-generated nonce, a permanent AIoT device identifier, and an AIoT device-generated nonce into a HMAC function that outputs the first individual session key, and where to generate the second individual session key, the at least one processor is configured to cause the device to input the pre-shared security key, the network-generated nonce, the permanent AIoT device identifier, the AIoT device-generated nonce, and the first individual session key into the HMAC function that outputs the second individual session key; where to generate the first individual session key, the at least one processor is configured to cause the device to input the pre-shared security key, a network-generated nonce, a temporary AIoT device identifier, and an AIoT device-generated nonce into a HMAC function that outputs the first individual session key, and where to generate the second individual session key, the at least one processor is configured to cause the device to input the pre-shared security key, the network-generated nonce, the temporary AIoT device identifier, the AIoT device-generated nonce, and the first individual session key into the HMAC function that outputs the second individual session key.

The controller 1206 may manage input and output signals for the device 1200. The controller 1206 may also manage peripherals not integrated into the device 1200. In some implementations, the controller 1206 may utilize an operating system such as iOS®, ANDROID®, WINDOWS®, or other operating systems. In some implementations, the controller 1206 may be implemented as part of the processor 1202.

In some implementations, the device 1200 may include at least one transceiver 1208. In some other implementations, the device 1200 may have more than one transceiver 1208. The transceiver 1208 may represent a wireless transceiver. The transceiver 1208 may include one or more receiver chains 1210, one or more transmitter chains 1212, or a combination thereof.

A receiver chain 1210 may be configured to receive signals (e.g., control information, data, packets) over a wireless medium. For example, the receiver chain 1210 may include one or more antennas to receive a signal over the air or wireless medium. The receiver chain 1210 may include at least one amplifier (e.g., a low-noise amplifier (LNA)) configured to amplify the received signal. The receiver chain 1210 may include at least one demodulator configured to demodulate the receive signal and obtain the transmitted data by reversing the modulation technique applied during transmission of the signal. The receiver chain 1210 may include at least one decoder for decoding the demodulated signal to receive the transmitted data.

A transmitter chain 1212 may be configured to generate and transmit signals (e.g., control information, data, packets). The transmitter chain 1212 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 1212 may also include at least one power amplifier configured to amplify the modulated signal to an appropriate power level suitable for transmission over the wireless medium. The transmitter chain 1212 may also include one or more antennas for transmitting the amplified signal into the air or wireless medium.

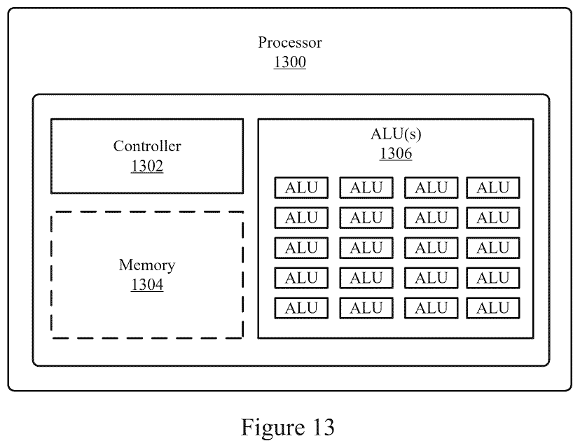

FIG. 13 illustrates an example of a processor 1300 in accordance with aspects of the present disclosure. The processor 1300 may be an example of a processor configured to perform various operations in accordance with examples as described herein. The processor 1300 may include a controller 1302 configured to perform various operations in accordance with examples as described herein. The processor 1300 may optionally include at least one memory 1304, which may be, for example, an L1/L2/L3 cache. Additionally, or alternatively, the processor 1300 may optionally include one or more arithmetic-logic units (ALUs) 1306. One or more of these components may be in electronic communication or otherwise coupled (e.g., operatively, communicatively, functionally, electronically, electrically) via one or more interfaces (e.g., buses).

The processor 1300 may be a processor chipset and include a protocol stack (e.g., a software stack) executed by the processor chipset to perform various operations (e.g., receiving, obtaining, retrieving, transmitting, outputting, forwarding, storing, determining, identifying, accessing, writing, reading) in accordance with examples as described herein. The processor chipset may include one or more cores, one or more caches (e.g., memory local to or included in the processor chipset (e.g., the processor 1300) or other memory (e.g., random access memory (RAM), read-only memory (ROM), dynamic RAM (DRAM), synchronous dynamic RAM (SDRAM), static RAM (SRAM), ferroelectric RAM (FeRAM), magnetic RAM (MRAM), resistive RAM (RRAM), flash memory, phase change memory (PCM), and others).

The controller 1302 may be configured to manage and coordinate various operations (e.g., signaling, receiving, obtaining, retrieving, transmitting, outputting, forwarding, storing, determining, identifying, accessing, writing, reading) of the processor 1300 to cause the processor 1300 to support various operations in accordance with examples as described herein. For example, the controller 1302 may operate as a control unit of the processor 1300, generating control signals that manage the operation of various components of the processor 1300. These control signals include enabling or disabling functional units, selecting data paths, initiating memory access, and coordinating timing of operations.

The controller 1302 may be configured to fetch (e.g., obtain, retrieve, receive) instructions from the memory 1304 and determine subsequent instruction(s) to be executed to cause the processor 1300 to support various operations in accordance with examples as described herein. The controller 1302 may be configured to track memory addresses of instructions associated with the memory 1304. The controller 1302 may be configured to decode instructions to determine the operation to be performed and the operands involved. For example, the controller 1302 may be configured to interpret the instruction and determine control signals to be output to other components of the processor 1300 to cause the processor 1300 to support various operations in accordance with examples as described herein. Additionally, or alternatively, the controller 1302 may be configured to manage flow of data within the processor 1300. The controller 1302 may be configured to control transfer of data between registers, ALUs 1306, and other functional units of the processor 1300.

The memory 1304 may include one or more caches (e.g., memory local to or included in the processor 1300 or other memory, such as RAM, ROM, DRAM, SDRAM, SRAM, MRAM, flash memory, etc. In some implementations, the memory 1304 may reside within or on a processor chipset (e.g., local to the processor 1300). In some other implementations, the memory 1304 may reside external to the processor chipset (e.g., remote to the processor 1300).

The memory 1304 may store computer-readable, computer-executable code including instructions that, when executed by the processor 1300, cause the processor 1300 to perform various functions described herein. The code may be stored in a non-transitory computer-readable medium such as system memory or another type of memory. The controller 1302 and/or the processor 1300 may be configured to execute computer-readable instructions stored in the memory 1304 to cause the processor 1300 to perform various functions. For example, the processor 1300 and/or the controller 1302 may be coupled with or to the memory 1304, the processor 1300, and the controller 1302, and may be configured to perform various functions described herein. In some examples, the processor 1300 may include multiple processors and the memory 1304 may include multiple memories. One or more of the multiple processors may be coupled with one or more of the multiple memories, which may, individually or collectively, be configured to perform various functions herein.

The one or more ALUs 1306 may be configured to support various operations in accordance with examples as described herein. In some implementations, the one or more ALUs 1306 may reside within or on a processor chipset (e.g., the processor 1300). In some other implementations, the one or more ALUs 1306 may reside external to the processor chipset (e.g., the processor 1300). One or more ALUs 1306 may perform one or more computations such as addition, subtraction, multiplication, and division on data. For example, one or more ALUs 1306 may receive input operands and an operation code, which determines an operation to be executed. One or more ALUs 1306 may be configured with a variety of logical and arithmetic circuits, including adders, subtractors, shifters, and logic gates, to process and manipulate the data according to the operation. Additionally, or alternatively, the one or more ALUs 1306 may support logical operations such as AND, OR, exclusive-OR (XOR), not-OR (NOR), and not-AND (NAND), enabling the one or more ALUs 1306 to handle conditional operations, comparisons, and bitwise operations.

The processor 1300 may support wireless communication in accordance with examples as disclosed herein. The processor 1300 may be configured to or operable to support at least one controller (e.g., the controller 1302) coupled with at least one memory (e.g., the memory 1304) and configured to cause the processor to: receive a first request; generate an individual temporary ID for the device; generate a first individual session key for the device based at least in part on a pre-shared security key corresponding to the device; transmit a response that includes the temporary ID.

Additionally, the processor 1300 may be configured to or operable to support any one or combination of the at least one processor is operable to cause the device to: receive a second request; generate a second individual session key for the device based at least in part on the first individual session key; where the device comprises an AIoT device; where to generate the first individual session key, the at least one processor is configured to cause the device to input the pre-shared security key, a network-generated nonce, and a permanent AIoT device identifier into a HMAC function that outputs the first individual session key, and where to generate the second individual session key, the at least one processor is configured to cause the device to input the pre-shared security key, the network-generated nonce, the permanent AIoT device identifier, and the first individual session key into the HMAC function that outputs the second individual session key; where to generate the first individual session key, the at least one processor is configured to cause the device to input the pre-shared security key, a network-generated nonce, and a temporary AIoT device identifier into a HMAC function that outputs the first individual session key, and where to generate the second individual session key, the at least one processor is configured to cause the device to input the pre-shared security key, the network-generated nonce, the temporary AIoT device identifier, and the first individual session key into the HMAC function that outputs the second individual session key; where to generate the first individual session key, the at least one processor is configured to cause the device to input the pre-shared security key into a HMAC function that outputs the first individual session key, and where to generate the second individual session key, the at least one processor is configured to cause the device to input the pre-shared security key and the first individual session key into the HMAC function that outputs the second individual session key; where to generate the first individual session key, the at least one processor is configured to cause the device to input the pre-shared security key and a network-generated nonce into a HMAC function that outputs the first individual session key, and where to generate the second individual session key, the at least one processor is configured to cause the device to input the pre-shared security key, the network-generated nonce, and the first individual session key into the HMAC function that outputs the second individual session key; where to generate the first individual session key, the at least one processor is configured to cause the device to input the pre-shared security key, a network-generated nonce, a permanent AIoT device identifier, and an AIoT device-generated nonce into a HMAC function that outputs the first individual session key, and where to generate the second individual session key, the at least one processor is configured to cause the device to input the pre-shared security key, the network-generated nonce, the permanent AIoT device identifier, the AIoT device-generated nonce, and the first individual session key into the HMAC function that outputs the second individual session key; where to generate the first individual session key, the at least one processor is configured to cause the device to input the pre-shared security key, a network-generated nonce, a temporary AIoT device identifier, and an AIoT device-generated nonce into a HMAC function that outputs the first individual session key, and where to generate the second individual session key, the at least one processor is configured to cause the device to input the pre-shared security key, the network-generated nonce, the temporary AIoT device identifier, the AIoT device-generated nonce, and the first individual session key into the HMAC function that outputs the second individual session key.

The processor 1300 may support wireless communication in accordance with examples as disclosed herein. The processor 1300 may be configured to or operable to support at least one controller (e.g., the controller 1302) coupled with at least one memory (e.g., the memory 1304) and configured to cause the processor to: generate, for a first request and based at least in part on a pre-shared security key, a first individual session key for an AIoT device; and generate, for a second request and based at least in part on the first individual session key, a second individual session key for the AIoT device.

Additionally, the processor 1300 may be configured to or operable to support any one or combination of transmit a request for device profile information corresponding to a target device information that identifies the AIoT device; and receive a permanent AIoT device identifier and the pre-shared security key that correspond to the AIoT device; where the NE implements an AIoTF; where to transmit the request, the at least one processor is operable to cause the NE to transmit the request to an apparatus that implements ADM; where the at least one processor is operable to cause the NE to: receive a request for device profile information corresponding to a target device information; generate an individual temporary identifier for the AIoT device that is identified by the target device information; and transmit the temporary identifier for the AIoT device, and at least one of the first individual session key or the second individual session key for the AIoT device; where the NE implements ADM; where to receive the request, the at least one processor is operable to cause the NE to receive the request from an apparatus that implements an AIoTF; where to generate the first individual session key, the at least one processor is configured to cause the NE to input the pre-shared security key into a HMAC function that outputs the first individual session key, and where to generate the second individual session key, the at least one processor is configured to cause the NE to input the pre-shared security key and the first individual session key into the HMAC function that outputs the second individual session key; where to generate the first individual session key, the at least one processor is configured to cause the NE to input the pre-shared security key and a network-generated nonce into a HMAC function that outputs the first individual session key, and where to generate the second individual session key, the at least one processor is configured to cause the NE to input the pre-shared security key, the network-generated nonce, and the first individual session key into the HMAC function that outputs the second individual session key; where to generate the first individual session key, the at least one processor is configured to cause the NE to input the pre-shared security key, a network-generated nonce, and a permanent AIoT device identifier into a HMAC function that outputs the first individual session key, and where to generate the second individual session key, the at least one processor is configured to cause the NE to input the pre-shared security key, the network-generated nonce, the permanent AIoT device identifier, and the first individual session key into the HMAC function that outputs the second individual session key; where to generate the first individual session key, the at least one processor is configured to cause the NE to input the pre-shared security key, a network-generated nonce, and a temporary AIoT device identifier into a HMAC function that outputs the first individual session key, and where to generate the second individual session key, the at least one processor is configured to cause the NE to input the pre-shared security key, the network-generated nonce, the temporary AIoT device identifier, and the first individual session key into the HMAC function that outputs the second individual session key; where to generate the first individual session key, the at least one processor is configured to cause the NE to input the pre-shared security key, a network-generated nonce, a permanent AIoT device identifier, and an AIoT device-generated nonce into a HMAC function that outputs the first individual session key, and where to generate the second individual session key, the at least one processor is configured to cause the NE to input the pre-shared security key, the network-generated nonce, the permanent AIoT device identifier, the AIoT device-generated nonce, and the first individual session key into the HMAC function that outputs the second individual session key; where to generate the first individual session key, the at least one processor is configured to cause the NE to input the pre-shared security key, a network-generated nonce, a temporary AIoT device identifier, and an AIoT device-generated nonce into a HMAC function that outputs the first individual session key, and where to generate the second individual session key, the at least one processor is configured to cause the NE to input the pre-shared security key, the network-generated nonce, the temporary AIoT device identifier, the AIoT device-generated nonce, and the first individual session key into the HMAC function that outputs the second individual session key.

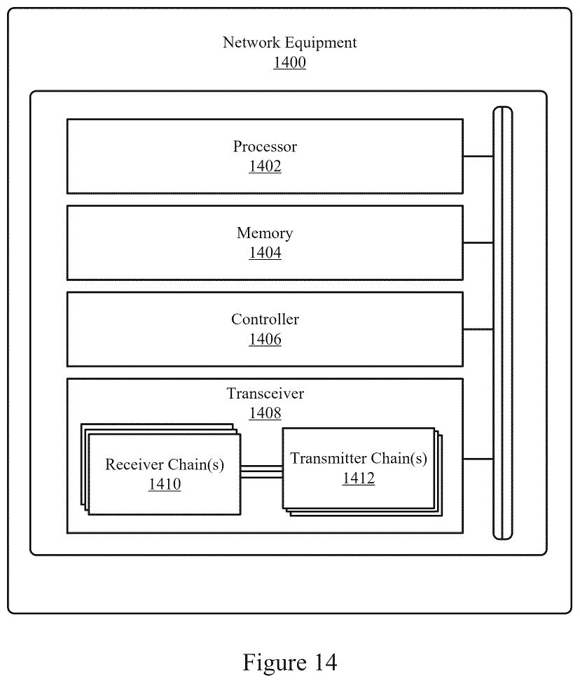

FIG. 14 illustrates an example of an NE 1400 in accordance with aspects of the present disclosure. The NE 1400 may include a processor 1402, a memory 1404, a controller 1406, and a transceiver 1408. The processor 1402, the memory 1404, the controller 1406, or the transceiver 1408, or various combinations thereof or various components thereof may be examples of means for performing various aspects of the present disclosure as described herein. These components may be coupled (e.g., operatively, communicatively, functionally, electronically, electrically) via one or more interfaces.

The processor 1402, the memory 1404, the controller 1406, or the transceiver 1408, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 1402 may include an intelligent hardware device (e.g., a general-purpose processor, a DSP, a CPU, an ASIC, an FPGA, or any combination thereof). In some implementations, the processor 1402 may be configured to operate the memory 1404. In some other implementations, the memory 1404 may be integrated into the processor 1402. The processor 1402 may be configured to execute computer-readable instructions stored in the memory 1404 to cause the NE 1400 to perform various functions of the present disclosure.

The memory 1404 may include volatile or non-volatile memory. The memory 1404 may store computer-readable, computer-executable code including instructions when executed by the processor 1402 cause the NE 1400 to perform various functions described herein. The code may be stored in a non-transitory computer-readable medium such as the memory 1404 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 1402 and the memory 1404 coupled with the processor 1402 may be configured to cause the NE 1400 to perform one or more of the functions described herein (e.g., executing, by the processor 1402, instructions stored in the memory 1404). For example, the processor 1402 may support wireless communication at the NE 1400 in accordance with examples as disclosed herein. The NE 1400 may be configured to support a means for generating, for a first request and based at least in part on a pre-shared security key, a first individual session key for an AIoT device; and generating, for a second request and based at least in part on the first individual session key, a second individual session key for the AIoT device.

Additionally, the NE 1400 may be configured to support any one or combination of transmitting a request for device profile information corresponding to a target device information that identifies the AIoT device; and receiving a permanent AIoT device identifier and the pre-shared security key that correspond to the AIoT device; where the NE implements an AIoTF; where transmitting the request includes transmitting the request to an apparatus that implements ADM; further including receiving a request for device profile information corresponding to a target device information; generating an individual temporary identifier for the AIoT device that is identified by the target device information; and transmitting the temporary identifier for the AIoT device, and at least one of the first individual session key or the second individual session key for the AIoT device; where the NE implements ADM; where receiving the request includes receiving the request from an apparatus that implements an AIoTF; where generating the first individual session key includes inputting the pre-shared security key into a HMAC function that outputs the first individual session key, and where generating the second individual session key includes inputting the pre-shared security key and the first individual session key into the HMAC function that outputs the second individual session key; where generating the first individual session key includes inputting the pre-shared security key and a network-generated nonce into a HMAC function that outputs the first individual session key, and where generating the second individual session key includes inputting the pre-shared security key, the network-generated nonce, and the first individual session key into the HMAC function that outputs the second individual session key; where generating the first individual session key includes inputting the pre-shared security key, a network-generated nonce, and a permanent AIoT device identifier into a HMAC function that outputs the first individual session key, and where generating the second individual session key includes inputting the pre-shared security key, the network-generated nonce, the permanent AIoT device identifier, and the first individual session key into the HMAC function that outputs the second individual session key; where generating the first individual session key includes inputting the pre-shared security key, a network-generated nonce, and a temporary AIoT device identifier into a HMAC function that outputs the first individual session key, and where generating the second individual session key includes inputting the pre-shared security key, the network-generated nonce, the temporary AIoT device identifier, and the first individual session key into the HMAC function that outputs the second individual session key; where generating the first individual session key includes inputting the pre-shared security key, a network-generated nonce, a permanent AIoT device identifier, and an AIoT device-generated nonce into a HMAC function that outputs the first individual session key, and where generating the second individual session key includes inputting the pre-shared security key, the network-generated nonce, the permanent AIoT device identifier, the AIoT device-generated nonce, and the first individual session key into the HMAC function that outputs the second individual session key; where generating the first individual session key includes inputting the pre-shared security key, a network-generated nonce, a temporary AIoT device identifier, and an AIoT device-generated nonce into a HMAC function that outputs the first individual session key, and where generating the second individual session key includes inputting the pre-shared security key, the network-generated nonce, the temporary AIoT device identifier, the AIoT device-generated nonce, and the first individual session key into the HMAC function that outputs the second individual session key.

Additionally, or alternatively, the NE 1400 may support at least one memory (e.g., the memory 1404) and at least one processor (e.g., the processor 1402) coupled with the at least one memory and configured to cause the NE to: generate, for a first request and based at least in part on a pre-shared security key, a first individual session key for an AIoT device; and generate, for a second request and based at least in part on the first individual session key, a second individual session key for the AIoT device.

Additionally, the NE 1400 may be configured to support any one or combination of where the at least one processor is operable to cause the NE to: transmit a request for device profile information corresponding to a target device information that identifies the AIoT device; and receive a permanent AIoT device identifier and the pre-shared security key that correspond to the AIoT device; where the NE implements an AIoTF; where to transmit the request, the at least one processor is operable to cause the NE to transmit the request to an apparatus that implements ADM; where the at least one processor is operable to cause the NE to: receive a request for device profile information corresponding to a target device information; generate an individual temporary identifier for the AIoT device that is identified by the target device information; and transmit the temporary identifier for the AIoT device, and at least one of the first individual session key or the second individual session key for the AIoT device; where the NE implements ADM; where to receive the request, the at least one processor is operable to cause the NE to receive the request from an apparatus that implements an AIoTF; where to generate the first individual session key, the at least one processor is configured to cause the NE to input the pre-shared security key into a HMAC function that outputs the first individual session key, and where to generate the second individual session key, the at least one processor is configured to cause the NE to input the pre-shared security key and the first individual session key into the HMAC function that outputs the second individual session key; where to generate the first individual session key, the at least one processor is configured to cause the NE to input the pre-shared security key and a network-generated nonce into a HMAC function that outputs the first individual session key, and where to generate the second individual session key, the at least one processor is configured to cause the NE to input the pre-shared security key, the network-generated nonce, and the first individual session key into the HMAC function that outputs the second individual session key; where to generate the first individual session key, the at least one processor is configured to cause the NE to input the pre-shared security key, a network-generated nonce, and a permanent AIoT device identifier into a HMAC function that outputs the first individual session key, and where to generate the second individual session key, the at least one processor is configured to cause the NE to input the pre-shared security key, the network-generated nonce, the permanent AIoT device identifier, and the first individual session key into the HMAC function that outputs the second individual session key; where to generate the first individual session key, the at least one processor is configured to cause the NE to input the pre-shared security key, a network-generated nonce, and a temporary AIoT device identifier into a HMAC function that outputs the first individual session key, and where to generate the second individual session key, the at least one processor is configured to cause the NE to input the pre-shared security key, the network-generated nonce, the temporary AIoT device identifier, and the first individual session key into the HMAC function that outputs the second individual session key; where to generate the first individual session key, the at least one processor is configured to cause the NE to input the pre-shared security key, a network-generated nonce, a permanent AIoT device identifier, and an AIoT device-generated nonce into a HMAC function that outputs the first individual session key, and where to generate the second individual session key, the at least one processor is configured to cause the NE to input the pre-shared security key, the network-generated nonce, the permanent AIoT device identifier, the AIoT device-generated nonce, and the first individual session key into the HMAC function that outputs the second individual session key; where to generate the first individual session key, the at least one processor is configured to cause the NE to input the pre-shared security key, a network-generated nonce, a temporary AIoT device identifier, and an AIoT device-generated nonce into a HMAC function that outputs the first individual session key, and where to generate the second individual session key, the at least one processor is configured to cause the NE to input the pre-shared security key, the network-generated nonce, the temporary AIoT device identifier, the AIoT device-generated nonce, and the first individual session key into the HMAC function that outputs the second individual session key.

The controller 1406 may manage input and output signals for the NE 1400. The controller 1406 may also manage peripherals not integrated into the NE 1400. In some implementations, the controller 1406 may utilize an operating system such as iOS®, ANDROID®, WINDOWS®, or other operating systems. In some implementations, the controller 1406 may be implemented as part of the processor 1402.

In some implementations, the NE 1400 may include at least one transceiver 1408. In some other implementations, the NE 1400 may have more than one transceiver 1408. The transceiver 1408 may represent a wireless transceiver. The transceiver 1408 may include one or more receiver chains 1410, one or more transmitter chains 1412, or a combination thereof.

A receiver chain 1410 may be configured to receive signals (e.g., control information, data, packets) over a wireless medium. For example, the receiver chain 1410 may include one or more antennas to receive a signal over the air or wireless medium. The receiver chain 1410 may include at least one amplifier (e.g., a low-noise amplifier (LNA)) configured to amplify the received signal. The receiver chain 1410 may include at least one demodulator configured to demodulate the receive signal and obtain the transmitted data by reversing the modulation technique applied during transmission of the signal. The receiver chain 1410 may include at least one decoder for decoding the demodulated signal to receive the transmitted data.

A transmitter chain 1412 may be configured to generate and transmit signals (e.g., control information, data, packets). The transmitter chain 1412 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 1412 may also include at least one power amplifier configured to amplify the modulated signal to an appropriate power level suitable for transmission over the wireless medium. The transmitter chain 1412 may also include one or more antennas for transmitting the amplified signal into the air or wireless medium.

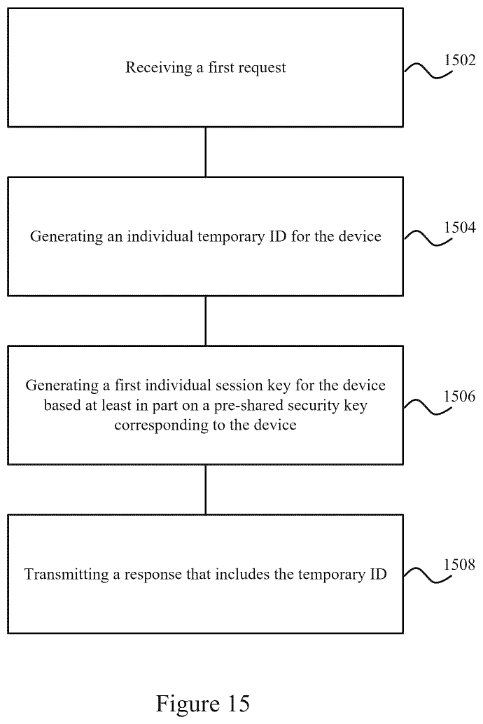

FIG. 15 illustrates a flowchart of a method in accordance with aspects of the present disclosure. The operations of the method may be implemented by a device as described herein, such as a UE, an AIoT device, or a low power device. In some implementations, the UE, AIoT device, or low power device may execute a set of instructions to control the function elements of the UE, AIoT device, or low power device to perform the described functions.

At 1502, the method may include receiving a first request. The operations of 1502 may be performed in accordance with examples as described herein. In some implementations, aspects of the operations of 1502 may be performed by a device as described with reference to FIG. 12.

At 1504, the method may include generating an individual temporary ID for the device. The operations of 1504 may be performed in accordance with examples as described herein. In some implementations, aspects of the operations of 1504 may be performed by a device as described with reference to FIG. 12.

At 1506, the method may include generating a first individual session key for the device based at least in part on a pre-shared security key corresponding to the device. The operations of 1506 may be performed in accordance with examples as described herein. In some implementations, aspects of the operations of 1506 may be performed a device as described with reference to FIG. 12.

At 1508, the method may include transmitting a response that includes the temporary ID. The operations of 1508 may be performed in accordance with examples as described herein. In some implementations, aspects of the operations of 1508 may be performed a device as described with reference to FIG. 12.

It should be noted that the method described herein describes a possible implementation, and that the operations and the steps may be rearranged or otherwise modified and that other implementations are possible.

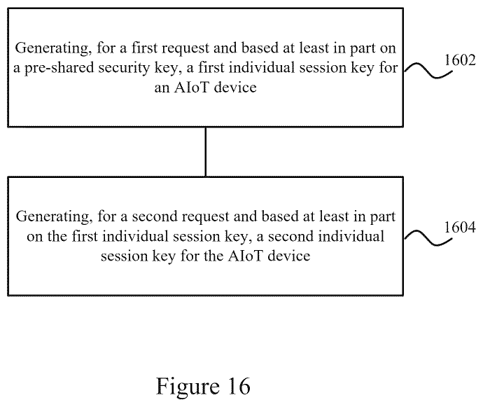

FIG. 16 illustrates a flowchart of a method in accordance with aspects of the present disclosure. The operations of the method may be implemented by an NE as described herein. In some implementations, the NE may execute a set of instructions to control the function elements of the NE to perform the described functions.

At 1602, the method may include generating, for a first request and based at least in part on a pre-shared security key, a first individual session key for an AIoT device. The operations of 1602 may be performed in accordance with examples as described herein. In some implementations, aspects of the operations of 1602 may be performed by an NE as described with reference to FIG. 14.

At 1604, the method may include generating, for a second request and based at least in part on the first individual session key, a second individual session key for the AIoT device. The operations of 1604 may be performed in accordance with examples as described herein. In some implementations, aspects of the operations of 1604 may be performed by an NE as described with reference to FIG. 14.

It should be noted that the method described herein describes a possible implementation, and that the operations and the steps may be rearranged or otherwise modified and that other implementations are possible.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A network equipment (NE) for wireless communication, comprising:
at least one memory; and
at least one processor coupled with the at least one memory and operable to cause the NE to:
generate, for a first request and based at least in part on a pre-shared security key, a first individual session key for an ambient Internet of things (AIoT) device; and
generate, for a second request and based at least in part on the first individual session key, a second individual session key for the AIoT device.

2. The NE of claim 1, wherein the at least one processor is operable to cause the NE to:
transmit a request for device profile information corresponding to a target device information that identifies the AIoT device; and
receive a permanent AIoT device identifier and the pre-shared security key that correspond to the AIoT device.

3. The NE of claim 2, wherein the NE implements an AIoT function (AIoTF).

4. The NE of claim 3, wherein to transmit the request, the at least one processor is operable to cause the NE to transmit the request to an apparatus that implements AIoT data management (ADM).

5. The NE of claim 1, wherein the at least one processor is operable to cause the NE to:
receive a request for device profile information corresponding to a target device information;
generate an individual temporary identifier for the AIoT device that is identified by the target device information; and
transmit the temporary identifier for the AIoT device, and at least one of the first individual session key or the second individual session key for the AIoT device.

6. The NE of claim 5, wherein the NE implements AIoT data management (ADM).

7. The NE of claim 6, wherein to receive the request, the at least one processor is operable to cause the NE to receive the request from an apparatus that implements an AIoT function (AIoTF).

8. The NE of claim 1, wherein to generate the first individual session key, the at least one processor is configured to cause the NE to input the pre-shared security key into a keyed-hash message authentication code (HMAC) function that outputs the first individual session key, and wherein to generate the second individual session key, the at least one processor is configured to cause the NE to input the pre-shared security key and the first individual session key into the HMAC function that outputs the second individual session key.

9. The NE of claim 1, wherein to generate the first individual session key, the at least one processor is configured to cause the NE to input the pre-shared security key and a network-generated nonce into a keyed-hash message authentication code (HMAC) function that outputs the first individual session key, and wherein to generate the second individual session key, the at least one processor is configured to cause the NE to input the pre-shared security key, the network-generated nonce, and the first individual session key into the HMAC function that outputs the second individual session key.

10. The NE of claim 1, wherein to generate the first individual session key, the at least one processor is configured to cause the NE to input the pre-shared security key, a network-generated nonce, and a permanent AIoT device identifier into a keyed-hash message authentication code (HMAC) function that outputs the first individual session key, and wherein to generate the second individual session key, the at least one processor is configured to cause the NE to input the pre-shared security key, the network-generated nonce, the permanent AIoT device identifier, and the first individual session key into the HMAC function that outputs the second individual session key.

11. The NE of claim 1, wherein to generate the first individual session key, the at least one processor is configured to cause the NE to input the pre-shared security key, a network-generated nonce, and a temporary AIoT device identifier into a keyed-hash message authentication code (HMAC) function that outputs the first individual session key, and wherein to generate the second individual session key, the at least one processor is configured to cause the NE to input the pre-shared security key, the network-generated nonce, the temporary AIoT device identifier, and the first individual session key into the HMAC function that outputs the second individual session key.

12. The NE of claim 1, wherein to generate the first individual session key, the at least one processor is configured to cause the NE to input the pre-shared security key, a network-generated nonce, a permanent AIoT device identifier, and an AIoT device-generated nonce into a keyed-hash message authentication code (HMAC) function that outputs the first individual session key, and wherein to generate the second individual session key, the at least one processor is configured to cause the NE to input the pre-shared security key, the network-generated nonce, the permanent AIoT device identifier, the AIoT device-generated nonce, and the first individual session key into the HMAC function that outputs the second individual session key.

13. The NE of claim 1, wherein to generate the first individual session key, the at least one processor is configured to cause the NE to input the pre-shared security key, a network-generated nonce, a temporary AIoT device identifier, and an AIoT device-generated nonce into a keyed-hash message authentication code (HMAC) function that outputs the first individual session key, and wherein to generate the second individual session key, the at least one processor is configured to cause the NE to input the pre-shared security key, the network-generated nonce, the temporary AIoT device identifier, the AIoT device-generated nonce, and the first individual session key into the HMAC function that outputs the second individual session key.

14. A device for wireless communication, comprising:
at least one memory; and
at least one processor coupled with the at least one memory and operable to cause the device to:
receive a first request;
generate an individual temporary identifier (ID) for the device;
generate a first individual session key for the device based at least in part on a pre-shared security key corresponding to the device;
transmit a response that includes the temporary ID.

15. The device of claim 14, wherein the at least one processor is operable to cause the device to:
receive a second request;
generate a second individual session key for the device based at least in part on the first individual session key.

16. The device of claim 14, wherein the device comprises an ambient Internet of things (AIoT) device.

17. The device of claim 15, wherein to generate the first individual session key, the at least one processor is configured to cause the device to input the pre-shared security key, a network-generated nonce, and a permanent ambient Internet of things (AIoT) device identifier into a keyed-hash message authentication code (HMAC) function that outputs the first individual session key, and wherein to generate the second individual session key, the at least one processor is configured to cause the device to input the pre-shared security key, the network-generated nonce, the permanent AIoT device identifier, and the first individual session key into the HMAC function that outputs the second individual session key.

18. The device of claim 15, wherein to generate the first individual session key, the at least one processor is configured to cause the device to input the pre-shared security key, a network-generated nonce, and a temporary ambient Internet of things (AIoT) device identifier into a keyed-hash message authentication code (HMAC) function that outputs the first individual session key, and wherein to generate the second individual session key, the at least one processor is configured to cause the device to input the pre-shared security key, the network-generated nonce, the temporary AIoT device identifier, and the first individual session key into the HMAC function that outputs the second individual session key.

19. A method performed by a network equipment (NE), the method comprising:
generating, for a first request and based at least in part on a pre-shared security key, a first individual session key for an ambient Internet of things (AIoT) device; and
generating, for a second request and based at least in part on the first individual session key, a second individual session key for the AIoT device.

20. A method performed by a device, the method comprising:
receiving a first request;
generating an individual temporary identifier (ID) for the device;
generating a first individual session key for the device based at least in part on a pre-shared security key corresponding to the device;
transmitting a response that includes the temporary ID.
